(19) United States
(12) Patent Application Publication
(10) Pub. No.: US 2014/0010284 A1
(43) Pub. Date: Jan. 9, 2014

(54) IMAGE TRANSFORM AND INVERSE TRANSFORM METHOD, AND IMAGE ENCODING AND DECODING DEVICE USING SAME

(71) Applicants: Yoon-mi Hong, Seoul (KR); Il-koo Kim, Osan-si (KR)

(72) Inventors: Yoon-mi Hong, Seoul (KR); Il-koo Kim, Osan-si (KR)

(73) Assignee: SAMSUNG ELECTRONICS CO., LTD., Suwon-si (KR)

(21) Appl. No.: 14/001,567

(22) PCT Filed: Feb. 24, 2012
(86) PCT No.: PCT/KR2012/001447

§ 371 Date: Sep. 26, 2013

Related U.S. Application Data
(60) Provisional application No. 61/446,656, filed on Feb. 25, 2011.

(51) Int. Cl. H04N 7/30

(52) U.S. Cl. CPC H04N 19/00812
USPC 375/240.2

(57) ABSTRACT

Provided are image transform/inverse transform methods and apparatuses. The image transform method substitutes a trigonometric function which is included in a discrete cosine transform (DCT) matrix with a rational number, and uses a scaling matrix in a scaling process that is performed in conjunction with quantization, in order to minimize a transform error due to the substituted DCT matrix.

### CROSS-REFERENCE TO RELATED APPLICATIONS

This application is a national stage entry of International Application No. PCT/KR2012/001447, filed on Feb. 24, 2012, and claims the benefit of U.S. Provisional Patent Application No. 61/446,656, filed on Feb. 25, 2011 in the U.S. Patent and Trademark Office, the disclosures of which are incorporated herein by reference in their entireties.

### TECHNICAL FIELD

Exemplary embodiments relate to an image encoding and decoding method and apparatus, and more particularly, to an improved transform and inverse transform method and apparatus for a block having a large size.

### BACKGROUND ART

In a video coding method such as H.264 and MPEG-4, a video sequence is hierarchically split into sequences, frames, slices, macroblocks, and blocks, and a block is a minimum processing unit. On an encoder side, prediction residue information of a block is obtained via intra-frame or inter-frame prediction, block transform is performed such that energy is focused on a small number of coefficients, and image data is compressed by performing quantization, scanning, run length coding, and entropy coding. On a decoder side, a block transform coefficient of the entropy coding is extracted from a bitstream, the prediction residue information of the block is reconstructed via inverse quantization and inverse transform, and prediction information is used to reconstruct video data of the block. In an encoding-decoding process, a transform module is a basis of video compression, and transform performance directly affects general performance of a coder/decoder (codec).

Discrete cosine transform (DCT) has been adopted in initial video coding standards such as MPEG-1 and H.261. The DCT has been widely used in the field of image and video coding since the DCT was proposed in 1974. The DCT removes correlations between image elements in a transform domain and provides a foundation for highly efficient image compression. However, because a DCT matrix is represented as a floating-point number, large amounts of system resources are used due to a correspondingly large amount of floating-point operations. There is an increasing demand for a new DCT algorithm that may improve transform efficiency and may transform a block having a large size.

### SUMMARY

A technical objective of the present disclosure is to provide an image transform/inverse transform method and apparatus that may reduce a computational complexity and increase a computational speed.

Exemplary embodiments provide an efficient transform algorithm that may perform a transform by using a transform matrix that substitutes a value of a trigonometric function with a rational number and may reduce a computational complexity of a transform process via a quantization process for compensating for a transform error due to the substituted transform matrix.

According to one or more exemplary embodiments, there may be provided an image transform and inverse transform method that may reduce a complexity and increase a computational speed via an integer-based operation process which is usable in lieu of a floating-point operation in order to transform and inverse transform a block having a large size.

Also, according to one or more exemplary embodiments, there may be provided a more efficient image transform and inverse transform method that may reduce a computational complexity by compensating for a difference value between a result value using substituted discrete cosine transform (DCT) and a result value by using an original DCT in a quantization step.

### BRIEF DESCRIPTION OF THE DRAWINGS

FIG. 1 is a diagram which illustrates an image encoding apparatus, according to an exemplary embodiment.

FIG. 2 is a flow graph which illustrates a discrete cosine transform (DCT), according to an exemplary embodiment.

FIG. 3A is an enlarged diagram which illustrates an operation structure 210 of FIG. 2, and FIG. 3B is an enlarged diagram which illustrates an operation structure 211 of FIG. 2.

FIG. 4 is a reference diagram which illustrates an operation process according to a flow graph of an operational structure 212 in the flow graph of the DCT of FIG. 2.

FIGS. 5A and 5B are reference diagrams which illustrate a process for simplifying an operation structure which includes a trigonometric function of a specific angle, according to another exemplary embodiment.

FIG. 6 illustrates a mapping table that approximates a value of a trigonometric function to a rational number, according to an exemplary embodiment.

FIG. 7 is a reference diagram which illustrates a process for changing a DCT process, according to another exemplary embodiment.

FIG. 8 is a diagram which illustrates an operation structure that changes a rotation transform included in a DCT process, according to another exemplary embodiment.

FIG. 9 is a diagram which illustrates an operation structure that changes a rotation transform, according to another exemplary embodiment.

FIG. 10 illustrates a mapping table which illustrates a rational number value that replaces a value of a trigonometric function, according to another exemplary embodiment.

FIGS. 11A, 11B, and 11C are diagrams which illustrates a DCT process, according to an exemplary embodiment.

FIGS. 12A, 12B, and 12C are diagrams which illustrate a discrete cosine inverse transform process, according to an exemplary embodiment.

FIGS. 13A, 13B, and 13C are diagrams which illustrate a DCT process, according to another exemplary embodiment.

FIGS. 14A, 14B, and 14C are diagrams which illustrate a discrete cosine inverse transform process, according to another exemplary embodiment.

FIG. 15 is a flowchart which illustrates an image transform process, according to an exemplary embodiment.

FIG. 16 is a flowchart which illustrates a quantization process, according to an exemplary embodiment.

FIG. 17 is a diagram which illustrates a scaling matrix which is applied to a transform value of a 32×32 block, according to an exemplary embodiment.

FIGS. 18A, 18B, 18C, 18D, 18E, and 18F illustrate a quantization matrix MF which is used to quantize a 32×32 block, according to an exemplary embodiment.

FIGS. 19A, 19B, 19C, 19D, 19E, and 19F illustrate an inverse quantization matrix V which is used to inverse quantize a 32×32 block, according to an exemplary embodiment.

FIGS. 20A, 20B, 20C, 20D, 20E, and 20F are diagrams which illustrate a quantization matrix MF which is applied to a transformed transform block based on a DCT matrix including an operation structure using a lifting scheme, according to another exemplary embodiment.

FIGS. 21A, 21B, 21C, 21D, 21E, and 21F are diagrams which illustrate an inverse quantization matrix V which is applied to a quantized transform block based on a discrete cosine inverse transform matrix including an operation structure using a lifting scheme, according to another exemplary embodiment.

FIG. 22 is a block diagram which illustrates an image decoding apparatus, according to an exemplary embodiment.

FIG. 23 is a flowchart which illustrates an image inverse transform method, according to an exemplary embodiment.

FIG. 24 is a flowchart which illustrates a process for obtaining an inverse quantization matrix V, according to an exemplary embodiment.

FIGS. 25, 26, 27, and 28 are mapping tables which are used for replacing a multiplication process, according to an exemplary embodiment.

### DETAILED DESCRIPTION

According to an aspect of one or more exemplary embodiments, there is provided an image transform method including: obtaining a substituted discrete cosine transform (DCT) matrix A by substituting values which are based on a trigonometric function from among elements of an N×N transform matrix, where N is an integer, that is usable for performing a one-dimensional (1D) DCT of an N×N block with rational number values; obtaining a scaling matrix S which is usable for compensating for a difference between result values of the substituted DCT matrix A and an original DCT matrix Original_A by using the substituted DCT matrix A and a transpose matrix A^{T} of the substituted DCT matrix A; transforming the N×N block by using the substituted DCT matrix A; and quantizing the transformed N×N block by using the scaling matrix S and a quantization step.

According to another aspect of one or more exemplary embodiments, there is provided an image inverse transform method including: receiving a transformed and quantized N×N block, where N is an integer; obtaining a substituted discrete cosine inverse transform matrix B by substituting values which are based on a trigonometric function from among elements of an N×N inverse transform matrix that is usable for performing a one-dimensional (1D) discrete cosine inverse transform of the N×N block with predetermined rational number values; obtaining a scaling matrix S which is usable for compensating for a difference between result values of the substituted discrete cosine inverse transform matrix B and an original discrete cosine inverse transform matrix Original_B by using the substituted discrete cosine inverse transform matrix B and a transpose matrix B^{T} of the substituted discrete cosine inverse transform matrix B; inverse quantizing the N×N block by using the scaling matrix S and a quantization step; and inverse transforming the inverse quantized N×N block by using the substituted discrete cosine inverse transform matrix B.

According to another aspect of one or more exemplary embodiments, there is provided an image encoding apparatus including: a transformer which is configured to transform an N×N block, where N is an integer, by using a substituted discrete cosine transform (DCT) matrix A that is obtainable by substituting values which are based on a trigonometric function from among elements of an N×N transform matrix that is usable for performing a one-dimensional (1D) DCT of the N×N block with predetermined rational number values; and a quantizer which is configured to quantize the transformed N×N block by using a quantization step and a scaling matrix S for compensating for a difference between result values of the substituted DCT matrix A and an original DCT matrix Original_A by using the substituted DCT matrix A and a transpose matrix A^{T} of the substituted DCT matrix A.

According to another aspect of one or more exemplary embodiments, there is provided an image decoding apparatus including: an inverse transformer which is configured to inverse transform a transformed and quantized N×N block, where N is an integer, by using a substituted discrete cosine inverse transform matrix B that is obtainable by substituting values which are based on a trigonometric function from among elements of an N×N inverse transform matrix which is usable for performing a one-dimensional (1D) discrete cosine inverse transform of the N×N block with predetermined rational number values; and an inverse quantizer which is configured to inverse quantize the transformed and quantized N×N block that is received by the inverse transformer by using a quantization step and a scaling matrix S for compensating for result values of the substituted discrete cosine inverse transform matrix B and an original discrete cosine inverse transform matrix Original_B by using the substituted discrete cosine inverse transform matrix B and a transpose matrix B^{T} of the substituted discrete cosine inverse transform matrix B.

The present inventive concept will now be described more fully with reference to the accompanying drawings, in which exemplary embodiments are shown.

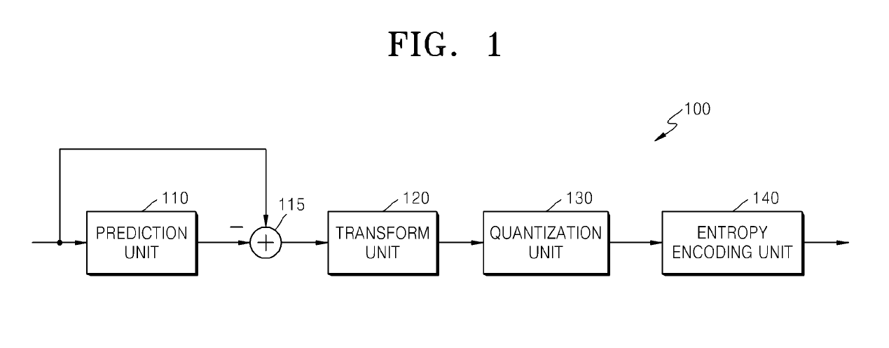

FIG. 1 is a diagram which illustrates an image encoding apparatus 100, according to an exemplary embodiment.

Referring to FIG. 1, the image encoding apparatus 100 includes a prediction unit 110 (also referred to herein as a predictor 110), a subtraction unit 115 (also referred to herein as a subtracter 115), a transform unit 120 (also referred to herein as a transformer 120), a quantization unit 130 (also referred to herein as a quantizer 130), and an entropy encoding unit 140 (also referred to herein as an entropy encoder 140).

The prediction unit 110 divides an input image into blocks which have predetermined sizes, and generates a prediction block via inter prediction or intra prediction which is performed on each of the blocks. In detail, the prediction unit 110 performs motion prediction that generates a motion vector indicating an area similar to a current block in a predetermined search range of a reference picture that has been previously encoded and restored, and intra prediction that generates a prediction block by using data of neighboring blocks which are adjacent to the current block.

The subtraction unit 115 generates a residual by subtracting the prediction block of the current block from original image data.

The transform unit 120 transforms the residual into a frequency domain. In particular, the transform unit 120 generates a transform coefficient by transforming a signal of an input N×N block, where N is an integer, into a frequency domain by using a substituted discrete cosine transform (DCT) matrix A that is obtainable by substituting, with predetermined rational number values, values which are based on a trigonometric function which is used in an algorithm, such as, for example, a Loeffler or Chen transform algorithm, that discrete cosine transforms an N×N transform matrix or the N×N block which is used for a DCT which is applicable to a block having a large size equal to or greater than 16×16. As will be described below, the transform unit 120 may perform DCT by using an integer-based sequence of additions and subtraction and a shift operation by substituting values of a trigonometric function in a multiplication factor which is included in an operation process of a transform matrix used in the DCT with rational number values. In terms of hardware, because a multiplication operation is substituted with a shift operation, a load applied to hardware may be reduced, and a computational complexity may be reduced, thereby increasing a computational speed with respect to the transform process.

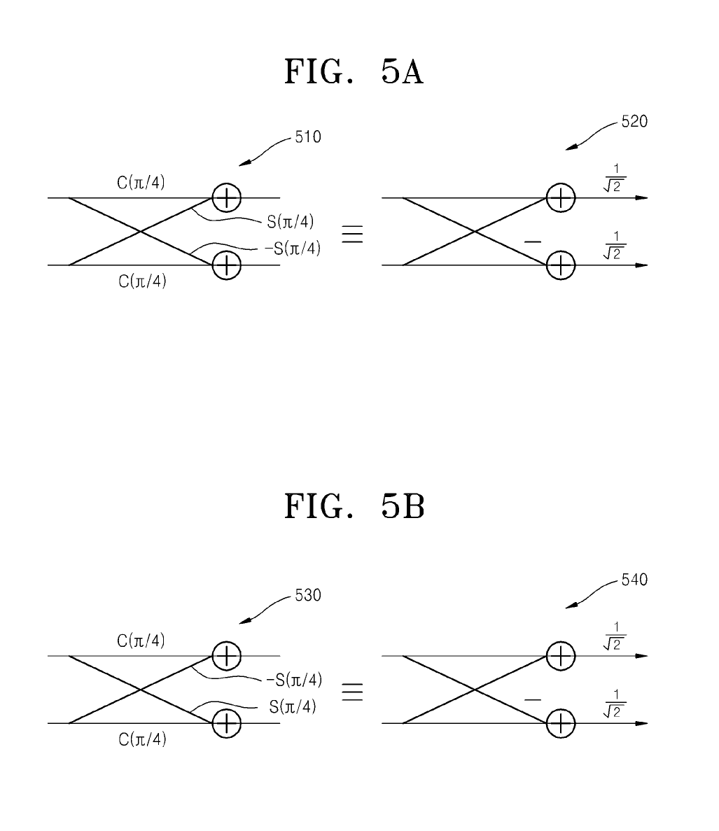

Alternatively, the transform unit 120 may change an operation process that corresponds to a rotation transform included in the DCT to a process which includes a smaller multiplication process while having the same result value. As will be described below, an operation process which is included in a flow graph for implementing an N×N DCT matrix corresponds to a rotation transform process that rotates an input signal by a predetermined angle. The rotation transform includes 4 multiplication processes and 2 addition processes. Alternatively, the transform unit 120 may perform a transform by replacing the rotation transform with 3 multiplication processes and 3 addition processes. A detailed alternative operation process will be described below with reference to FIGS. 5 through 9.

The quantization unit 130 quantizes the transformed residual. In particular, the quantization unit 130 reduces an error between a value which is obtainable by transforming an input signal by using a DCT matrix approximated in the transform unit 120 and a value which is obtainable by transforming an input signal by using an original DCT matrix, by combining a quantization process using a quantization step Qstep with a scaling process with respect to transform coefficients which are output from the transform unit 120. The quantization unit 130 generates a scaling matrix S which is based on a size of each of elements of the substituted DCT matrix A, and generates a quantization matrix MF including a scaling process based on the scaling matrix S. As will be described below, the scaling matrix S is a matrix which includes, as an element, a reciprocal of a square root of each of elements located on a diagonal from among elements of a multiplication matrix AA^{T} of the substituted DCT matrix A and a transpose matrix A^{T} of the substituted DCT matrix. The quantization unit 130 simultaneously performs the scaling process and the quantization process by applying the quantization matrix MF and the quantization step to a transform value which is output from the transform unit 120. The scaling process and the quantization process will be described below in detail.

The entropy encoding unit 140 generates a bitstream by performing variable length coding on quantized image data.

An image transform method according to an exemplary embodiment will now be described.

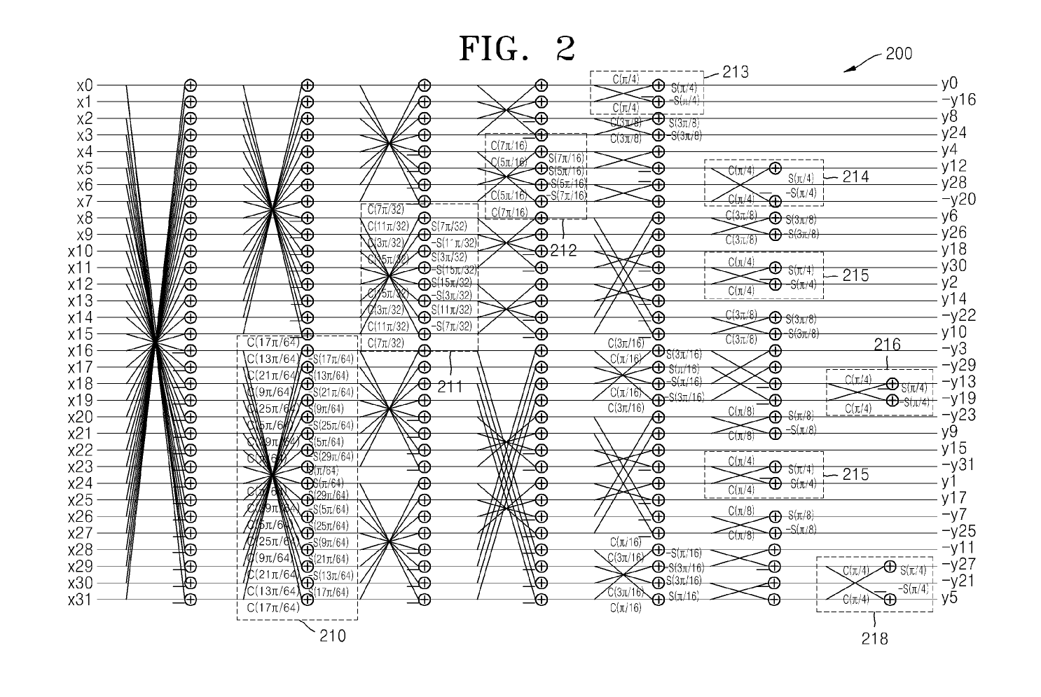

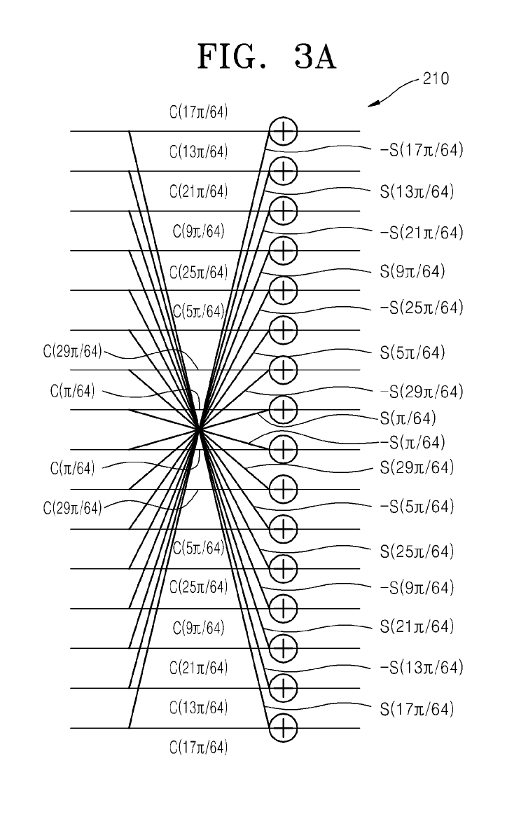

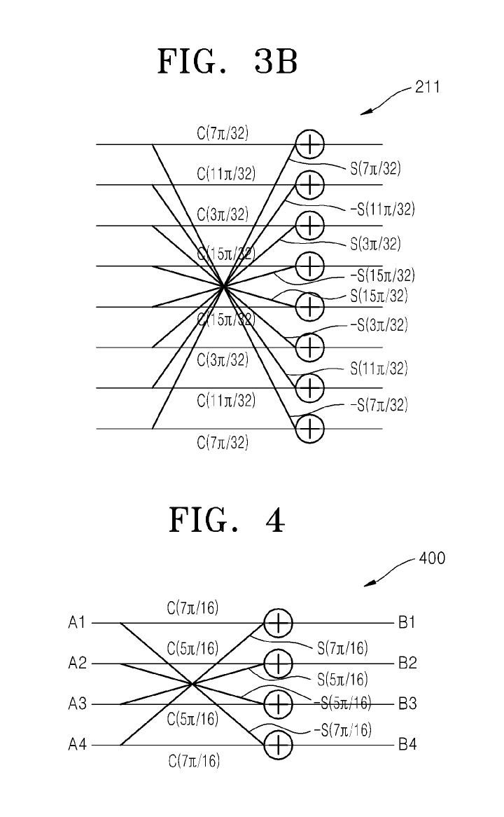

FIG. 2 is a flow graph which illustrates a DCT, according to an exemplary embodiment. FIG. 3A is an enlarged diagram which illustrates an operation structure 210 of FIG. 2. FIG. 3B is an enlarged diagram which illustrates an operation structure 211.

A flow graph of a 32-point DCT, as shown in FIG. 2, may be implemented from an arbitrary 16-point DCT algorithm by using characteristics of an N-point DCT matrix in which components of even-numbered (i.e., 0th, 2nd, . . . ) rows are symmetric and components of odd-numbered (i.e., 1st, 3rd, . . . ) rows are anti-symmetric Likewise, a 64-point DCT flow graph, a 128-point DCT flow graph, and a 256-point DCT flow graph may be obtained from the 32-point DCT flow graph of FIG. 2.

Referring to FIGS. 2, 3A, and 3B, x0 through x31 are input values of a DCT, and y0 through y31 are output values of the DCT. In discrete cosine inverse transform, x0 through x31 correspond to output values of a discrete cosine inverse transform, and y0 through y31 correspond to input values of the discrete cosine inverse transform. A data processing direction in DCT is from left to right, and a data processing direction in discrete cosine inverse transform is from right to left. A value on each line indicates a multiplication factor that is multiplied by a value passing through each line. Cθ indicates cos θ, and Sθ indicates sin θ. ‘−’ marked on a line indicates that when a multiplication factor is −1, −1 is multiplied by a signal which passes through the line. Because an operation of multiplying by −1 may be implemented by using a bit operation instead of a multiplication, the operation of multiplying by −1 is simpler than a multiplication operation that multiplies a value whose absolute value is not 1.

FIG. 4 is a reference diagram which illustrates an operation process according to a flow graph of an operational structure 212 in the DCT flow graph of FIG. 2.

Referring to FIG. 4, when an input signal is A1 through A4 and an output value is B1 through B4, B1 through B4 according to the flow graph of FIG. 4 may be obtained via performance of an operation process by using the following equations B1=A1*C(7π/16)+A4*S(7π/16); B2=A2*C(5π/16)+A3*S(5π/16); B3=−A2*S(5π/16)+A3*C(5π/16); and B4=−A1*S(7π/16)+A4*C(7π/16). Likewise, the DCT may be performed by performing an operation process such as multiplication, addition, and subtraction, on an input signal along each line according to the flow graph of FIG. 2.

Performing a DCT according to a DCT flow graph 200 has disadvantages, in that because Cθ and Sθ may be irrational numbers, depending on a value of θ, a computational complexity may be increased. In particular, because a DCT process which is based on a value of a trigonometric function includes a floating-point operation, a computational complexity may be increased. Accordingly, the image transform method of the present exemplary embodiment provides a transform method that approximates and substitutes a value of a trigonometric function which is used for performing a DCT with a rational number value, performs the DCT by using a substituted DCT matrix, and yields a result value which is most similar to the original DCT via scaling in a quantization step.

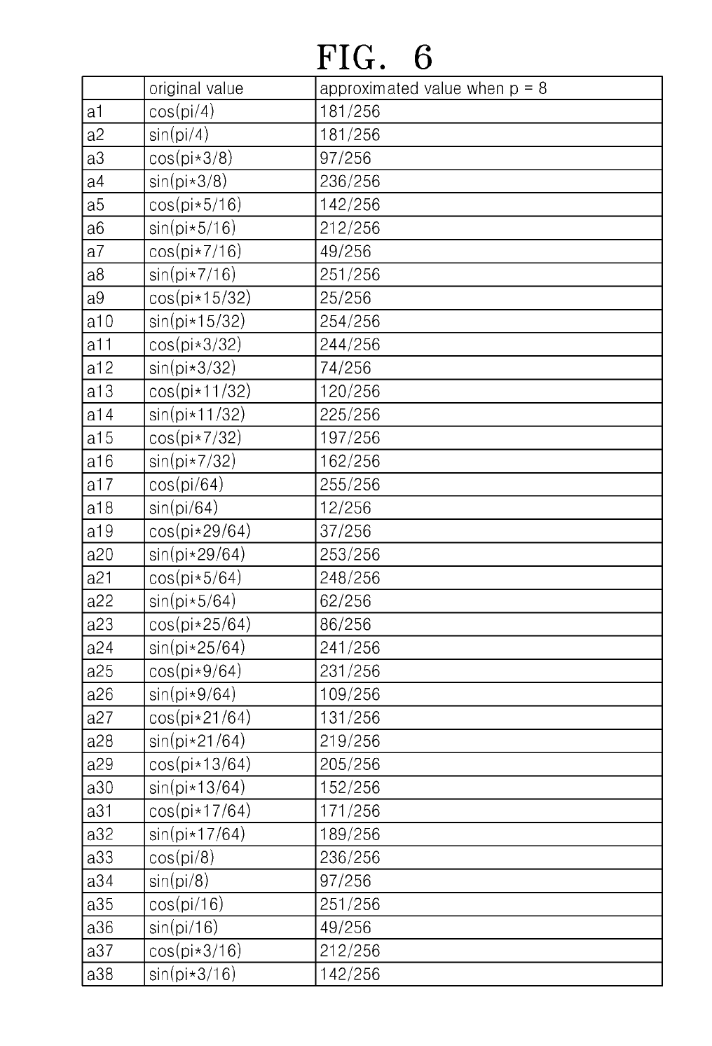

The transform unit 120 substitutes values of a trigonometric function which is included in a DCT algorithm based on an original N×N transform matrix Original_A with a rational number. In particular, the transform unit 120 substitutes a value of a trigonometric function with a rational number whose denominator is a power of 2, such as, for example, q/(2^{p}), where p and q are integers. The value p is a precision value. As the precision value p increases, a value may be more finely represented, and thus a value of a trigonometric function may be more accurately approximated to a rational number. FIG. 6 illustrates a mapping table that approximates a respective value of a trigonometric function to a corresponding rational number, according to an exemplary embodiment. FIG. 6 illustrates a mapping table which corresponds to a precision value p which is equal to 8, that is, a value of a trigonometric function is approximated to a rational number whose denominator is 2⁸=256.

As such, when a DCT process is performed by substituting a value of a trigonometric function with a rational number whose denominator is equal to a power of 2, because an operation process which uses the rational number whose denominator is a power of 2 may be performed by using a shift operation instead of a division, a computational complexity is reduced.

Operation processes which include a specific value of θ before an output value from among operation processes included in the DCT flow graph 200 of FIG. 2 may be simplified to a multiplication process.

FIGS. 5A and 5B are reference diagrams which illustrate a process for simplifying an operation structure which includes a trigonometric function of a specific angle, according to another exemplary embodiment.

Referring to FIG. 5, an operation structure 510 corresponds to operation structures 213, 214, 215, 217, and 218 of FIG. 2 when θ is π/4. The operation structure 510 corresponds to a rotation transform that rotates an input value [X1, X2] by π/4 and outputs [Y1, Y2], and may be expressed as the following equation

$$[ \begin{matrix}Y 1 \\ Y 2\end{matrix} ] = [ \begin{matrix}cos ( π / 4 ) & - sin ( π / 4 ) \\ sin ( π / 4 ) & cos ( π / 4 )\end{matrix} ] [ \begin{matrix}X 1 \\ X 2\end{matrix} ] .$$

Because cos(π/4) and sin(π/4) each have a value of 1/\sqrt{2}, the operation structure 510 may be substituted with an operation structure 520. According to the substituted operation structure 520, 1/\sqrt{2} is multiplied by the output value. An operation process of multiplying 1/\sqrt{2} may be performed in combination with a quantization process which will be described below.

Referring to FIG. 5B, an operation structure 530 corresponds to an operation structure 216 of FIG. 2 when θ has a value of −π/4. The operation structure 530 corresponds to a rotation transform that rotates an input value [X1, X2] by −π/4 and outputs [Y1, Y2] and may be expressed as the following equation

$$[ \begin{matrix}Y 1 \\ Y 2\end{matrix} ] = [ \begin{matrix}cos ( - π / 4 ) & - sin ( - π / 4 ) \\ sin ( - π / 4 ) & cos ( - π / 4 )\end{matrix} ] [ \begin{matrix}X 1 \\ X 2\end{matrix} ] .$$

Because cos(−π/4) has a value of 1/\sqrt{2} and sin(−π/4) has a value of −1/\sqrt{2}, the operation structure 530 may be substituted with an operation structure 540. An operation process of multiplying 1/\sqrt{2} may be performed in combination of a quantization process. Accordingly, alternatively, the transform unit 120 may substitute a value of a trigonometric function which is included in the flow graph 200 of FIG. 2 with a rational number, and may perform a transform based on a DCT algorithm that substitutes any of the operation structures 213, 214, 215, 217, and 218 with the operation structure 520 of FIG. 5A and substitutes the operation structure 216 with the operation structure 540 of FIG. 5B.

A transform process which is performed on a block having a relatively large size includes more operation processes than a transform process which is performed on a block having a relatively small size. In general, because a multiplication is more complex and takes more time than an addition, a subtraction, and a shift operation, the multiplication slows down overall computation. Accordingly, it is preferable that the number of multiplications necessary for a transform process is reduced. Alternatively, the transform unit 120 may perform a transform based on a changed butterfly operation structure which is obtainable by substituting 4 multiplications and 2 additions which are included in a specific operation structure (hereinafter, referred to as a “butterfly operation structure”) included in a DCT process based on the flow graph 200 of FIG. 2 with 3 multiplications and 3 additions.

FIG. 7 is a reference diagram which illustrates a process for changing a DCT process, according to another exemplary embodiment.

Referring to FIG. 7, a process for obtaining result values Y1 and Y2 for input values X1 and X2 according to an operation structure 710 as shown on the left side of FIG. 7 is as follows.

Y1=a*X1+b*X2;Y2=b*X1−a*X2

In the operation structure 710 shown on the left side of FIG. 7, 4 multiplications and 2 additions or subtractions are necessary to obtain the result values Y1 and Y2. Result values Y1 and Y2 for input values X1 and X2 according to an operation of a changed operation structure 720 shown on the right side of FIG. 7 are as follows.

Y1=X1*(a−b)+b*(X1+X2)=a*X1+b*X2;

Y2=b*(X1+X2)−X2*(a+b)=b*X1−a*X2

According to the changed operation structure 720 shown on the right side of FIG. 7, because one multiplication in an operation of b*(X1+X2) is performed in b*(X1+X2) and its result value is used in both calculations of Y1 and Y2, 3 multiplications and 3 additions or subtractions are necessary. Accordingly, the same result value may be obtained and a computational speed may be increased by reducing a complex multiplication process by using the changed operation structure 720. Accordingly, the transform unit 120 may apply the changed operation structure 720 of FIG. 7 to the flow graph 200 of FIG. 2.

A rotation transform process may be changed to the following Equation 1 by using a lifting scheme.

$$[ \begin{matrix}cos α & - sin α \\ sin α & cos α\end{matrix} ] = [ \begin{matrix}1 & p \\ 0 & 1\end{matrix} ] [ \begin{matrix}1 & 0 \\ u & 1\end{matrix} ] [ \begin{matrix}1 & p \\ 0 & 1\end{matrix} ] . \qquad ( 1 )$$

In Equation 1, p=(cos α−1)/sin α, and u=sin α.

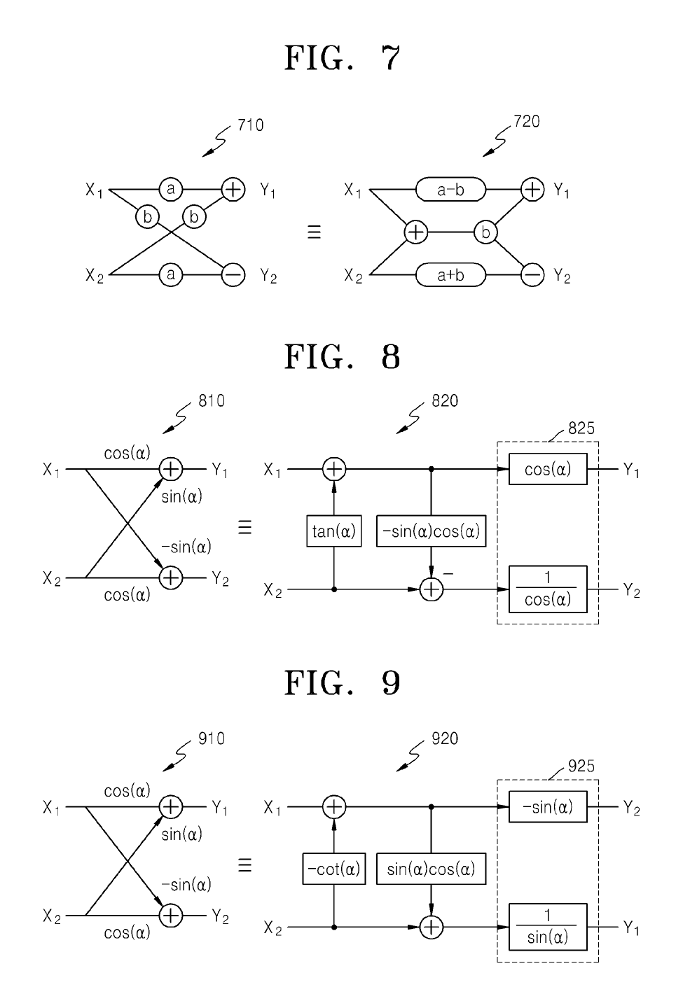

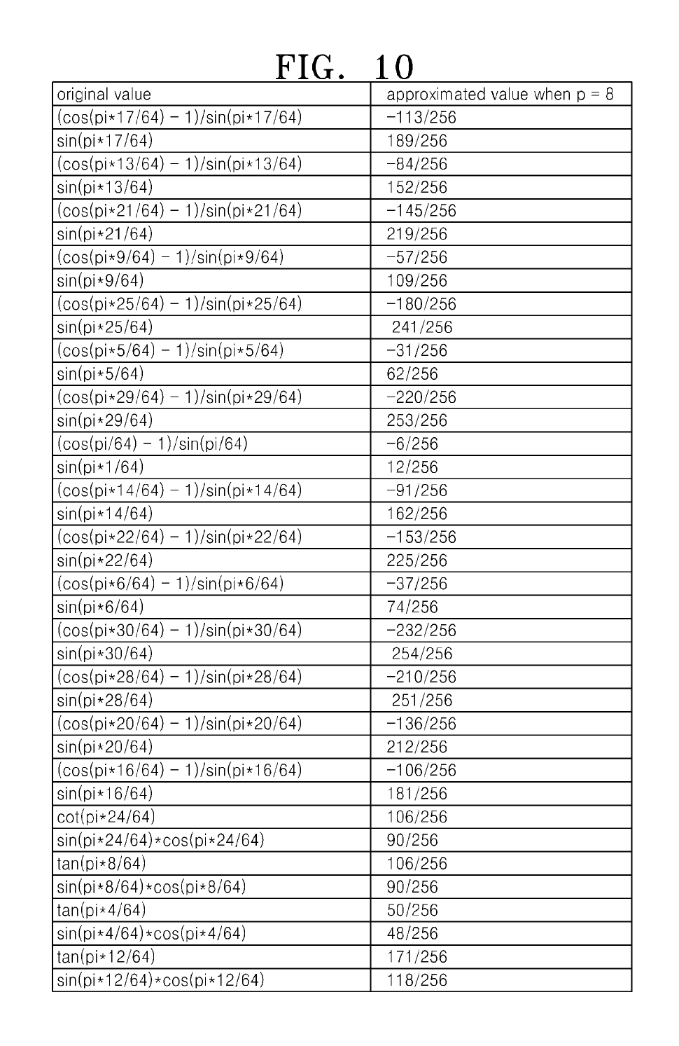

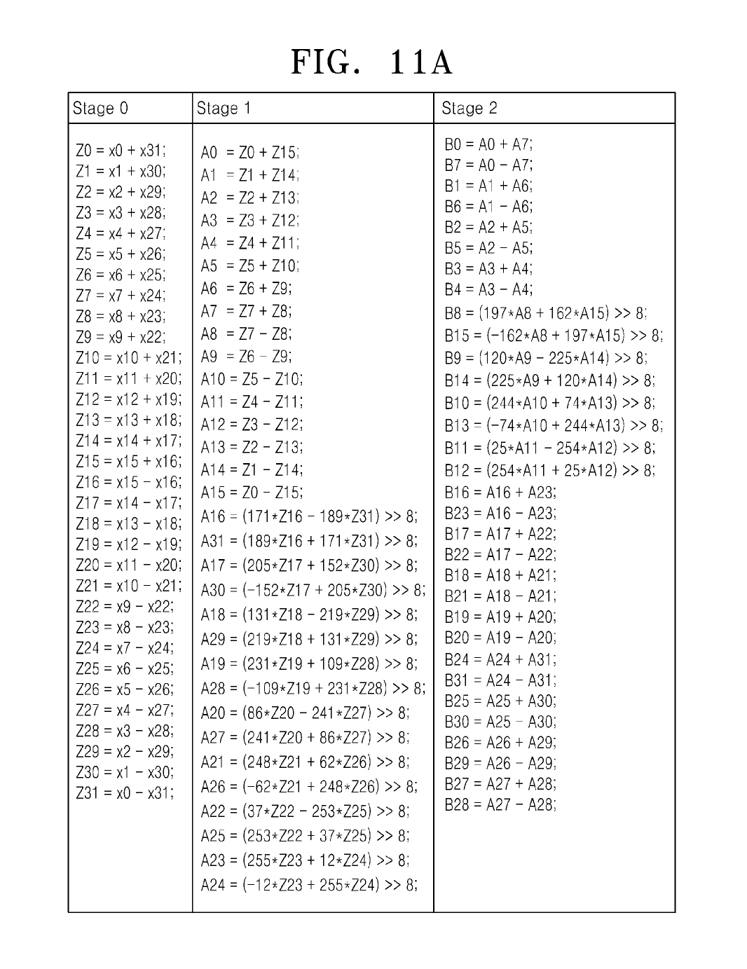

FIG. 8 is a diagram which illustrates an operation structure that changes a rotation transform which is included in a DCT process, according to another exemplary embodiment. FIG. 9 is a diagram which illustrates an operation structure that changes a rotation transform used for performing a transform, according to another exemplary embodiment.

Referring to FIG. 8, a rotation transform operation structure 810 as shown on the left side of FIG. 8 may be changed to an operation structure 820 which uses a lifting scheme as shown on the right side of FIG. 8 based on Equation 1. The operation structure 820 which uses the lifting scheme outputs the same result value as the rotation transform operation structure 810. The rotation transform operation structure 810 requires 4 multiplications and 2 additions (or subtractions), whereas the operation structure 820 which uses the lifting scheme requires 3 multiplications and 3 additions (or subtractions). Accordingly, when the operation structure 820 which uses the lifting scheme is used, because the number of multiplications is reduced while the same result value as the rotation transform operation structure 810 is obtained, a computational speed may be increased. In the operation structure 820 which uses the lifting scheme, a process for multiplying multiplication factors 825 of cos α or 1/cos α by an output value may be not performed in a transform process and may be performed in a quantization process instead by multiplying a scaling factor by the multiplication factor 825. The transform unit 120 may substitute any of the operation structures 213, 214, 215, 217, and 218 which are included in the flow graph of FIG. 2 with an operation structure 820 which uses a lifting scheme of FIG. 8, and may perform a transform by using a substituted DCT algorithm. If α>π/4, then tan α>1, so the transform unit 120 may substitute any of the operation structures 213, 214, 215, 217, and 218 which are included in the flow graph 200 of FIG. 2 with the operation structure 920 which uses a lifting scheme of FIG. 9, and may perform a transform according to a substituted DCT algorithm. That is, when an absolute value of α is greater than π/4, because an absolute value of tan α is greater than 1, the transform unit 120 may use the operation structure 920 which uses the lifting scheme of FIG. 9 instead of the operation structures 213, 214, 215, 217, and 218 which are included in the flow graph of FIG. 2.

Similarly as in FIG. 8, in the operation structure 920 which uses the lifting scheme of FIG. 9, a process for multiplying multiplication factors 925 of sin α or 1/sin α by an output value may be not performed in a transform process and may be performed in a quantization process instead by multiplying a scaling factor by the multiplication factor 925.

The operation structure 216 in the flow graph 200 of FIG. 2 may be substituted with the operation structures 820 and 920, each of which uses the lifting scheme. In detail, the transform unit 120 may use the operation structure 820 which uses the lifting scheme of FIG. 8 instead of the operation structure 216 in the flow graph 200 of FIG. 2. In this case, an operation is performed by using a value of (−α) instead of α. If an absolute value of α is greater than π/4, because an absolute value of tan α is greater than 1, the transform unit 120 may use the operation structure 920 which uses the lifting scheme of FIG. 9 instead of the operation structure 216 in the flow graph 200 of FIG. 2.

When the operation structures 820 and 920, each of which uses the lifting scheme, are applied to the flow graph 200 of FIG. 2, the transform unit 120 may perform a DCT by substituting an original value of a trigonometric function which is necessary for a DCT process, as shown in the left column of FIG. 10, with a approximated rational number, as shown in the right column of FIG. 10.

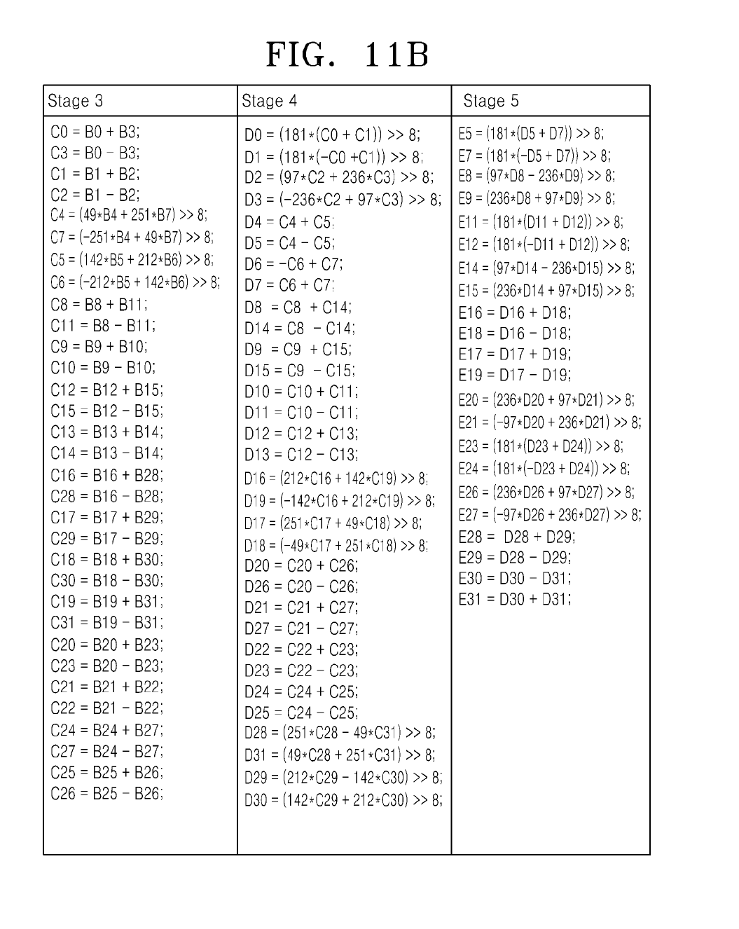

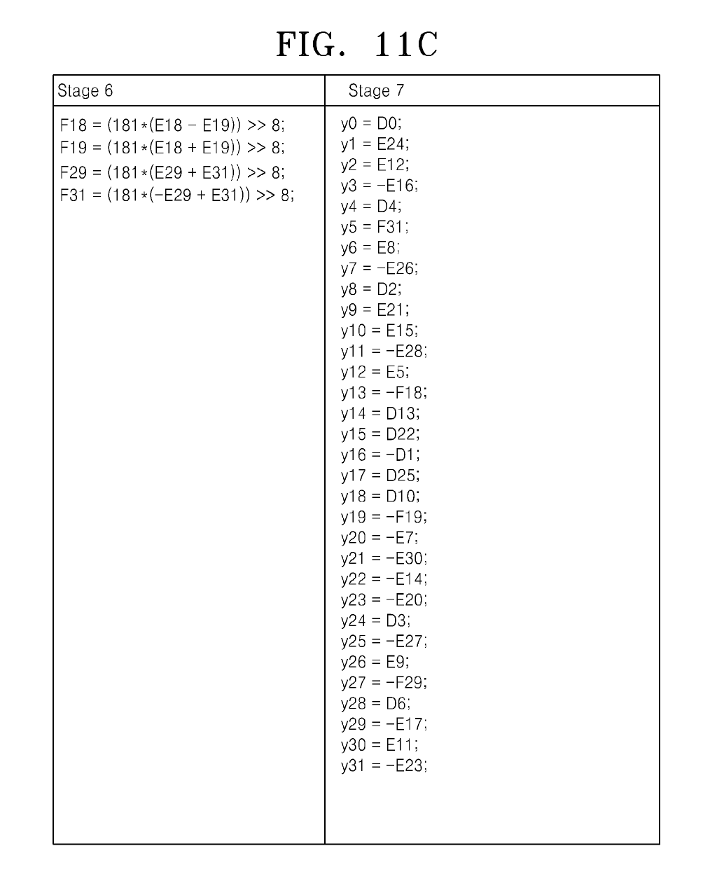

As described above, a step of performing a 32-point DCT process by using a substituted DCT matrix A may be performed via 7-stage addition, subtraction, and shift operation processes as shown in FIGS. 11A, 11B, and 11C. In FIGS. 11A, 11B, and 11C, X0 through X31 are input values to be transformed, Y0 through Y31 are transformed values, and the remaining values A0 through A31, B0 through B31, C0 through C31, D0 through D31, E0 through E31, and Z0 through Z31 are intermediate values.

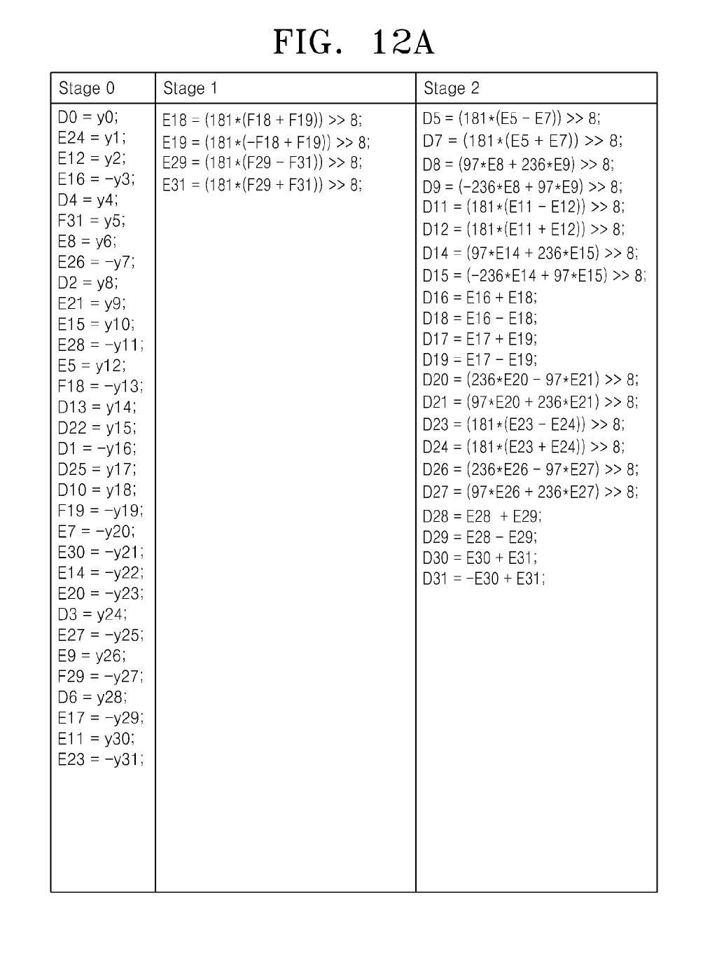

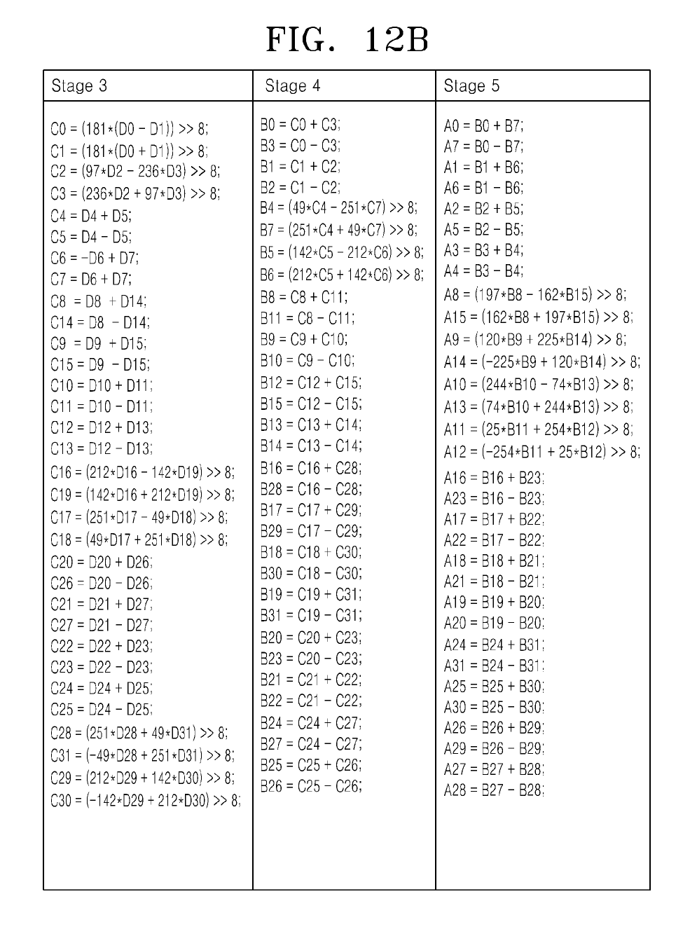

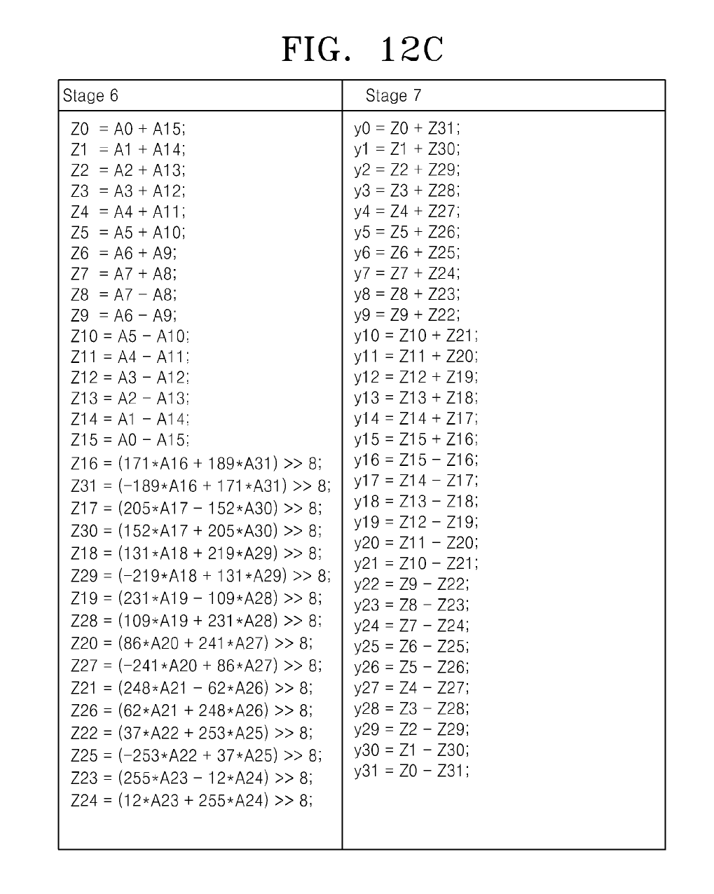

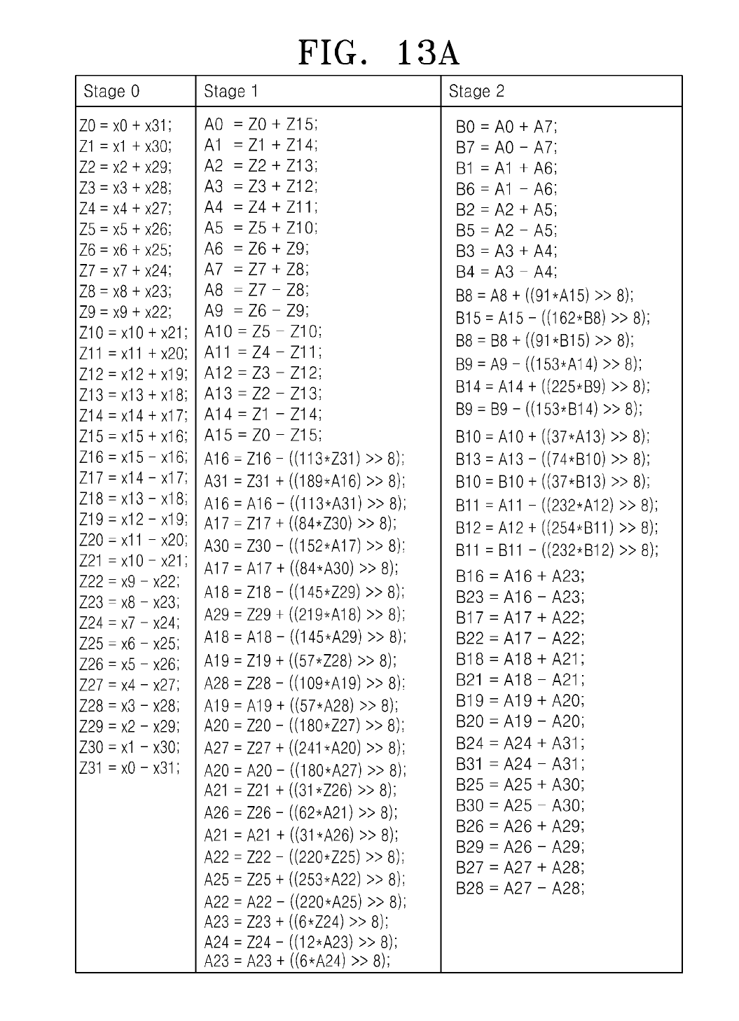

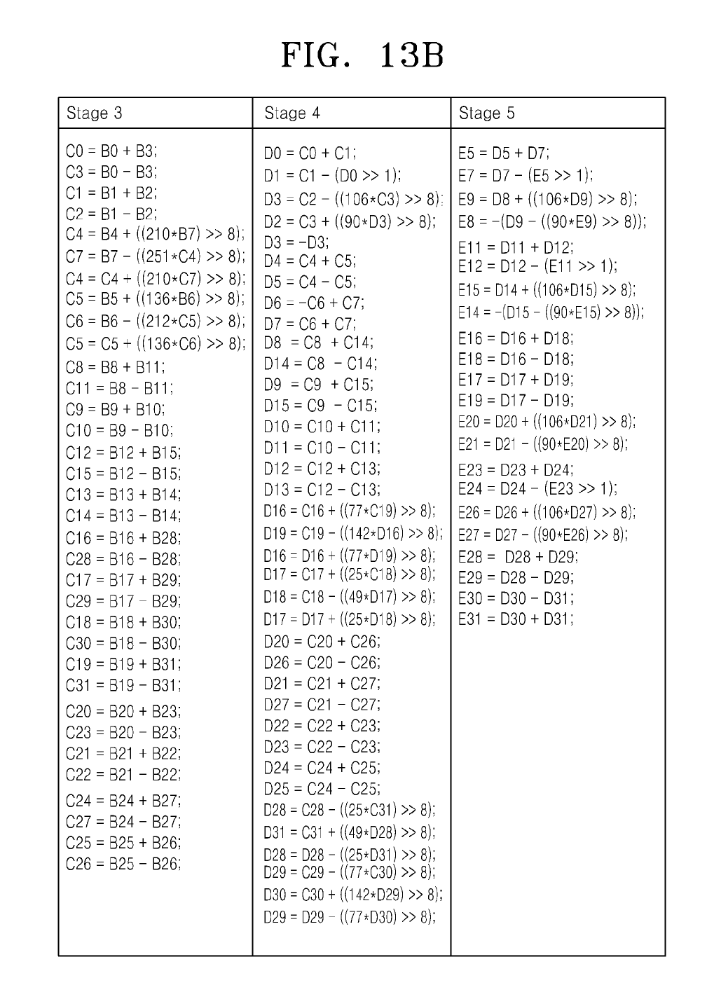

Similarly as described above with respect to a process for obtaining the substituted DCT matrix A, a value of a trigonometric function which is included in a discrete cosine inverse transform matrix Original_B that is an inverse matrix of a DCT matrix Original_A may be substituted with a rational number whose denominator is a power of 2, and a discrete cosine inverse transform may be performed by using a substituted discrete cosine inverse transform matrix B. A step of performing a 32-point discrete cosine inverse transform process by using the substituted discrete cosine inverse transform matrix B may be performed via 7-stage addition, subtraction, and shift operation processes as shown in FIGS. 12A, 12B, and 12C. In FIGS. 12A through 12C, Y0 through Y31 are input values to be inverse transformed, X0 through X31 are inverse transformed values, and the remaining values A0 through A31, B0 through B31, C0 through C31, D0 through D31, E0 through E31, and Z0 through Z31 are intermediate values.

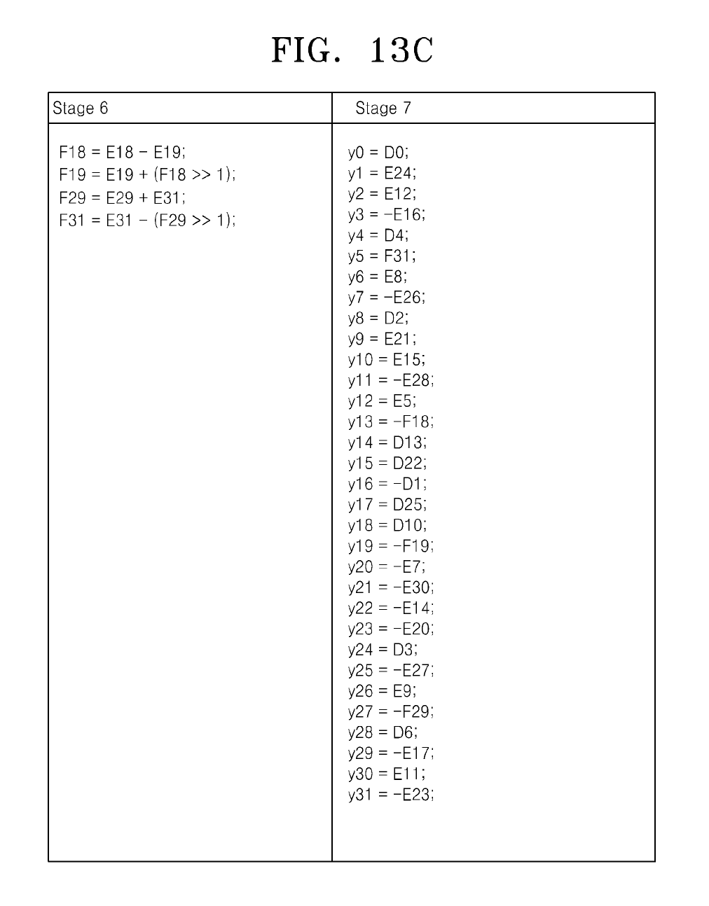

A step of performing a 32-point DCT process by applying the operation structures 820 and 920, each of which uses the lifting scheme, to the flow graph 200 of FIG. 2 may be performed via 7-stage addition, subtraction, and shift operation processes, as shown in FIGS. 13A, 13B, and 13C. In FIGS. 13A, 13B, and 13C, X0 through X31 are input values to be transformed, Y0 through Y31 are transformed values, and the remaining values A0 through A31, B0 through B31, C0 through C31, D0 through D31, E0 through E31, and Z0 through Z31 are intermediate values.

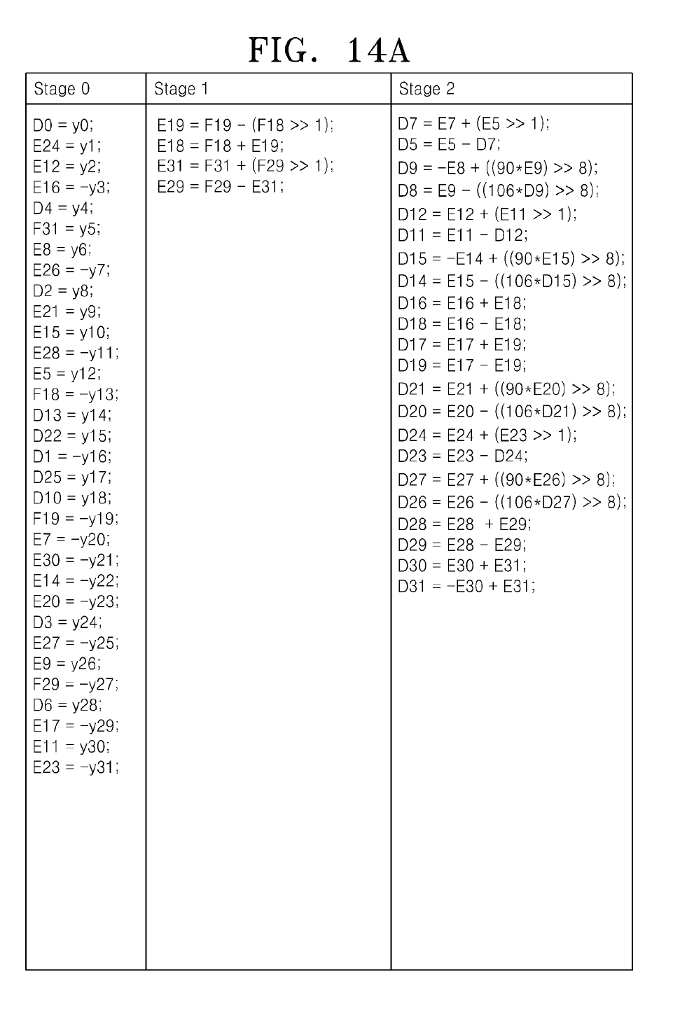

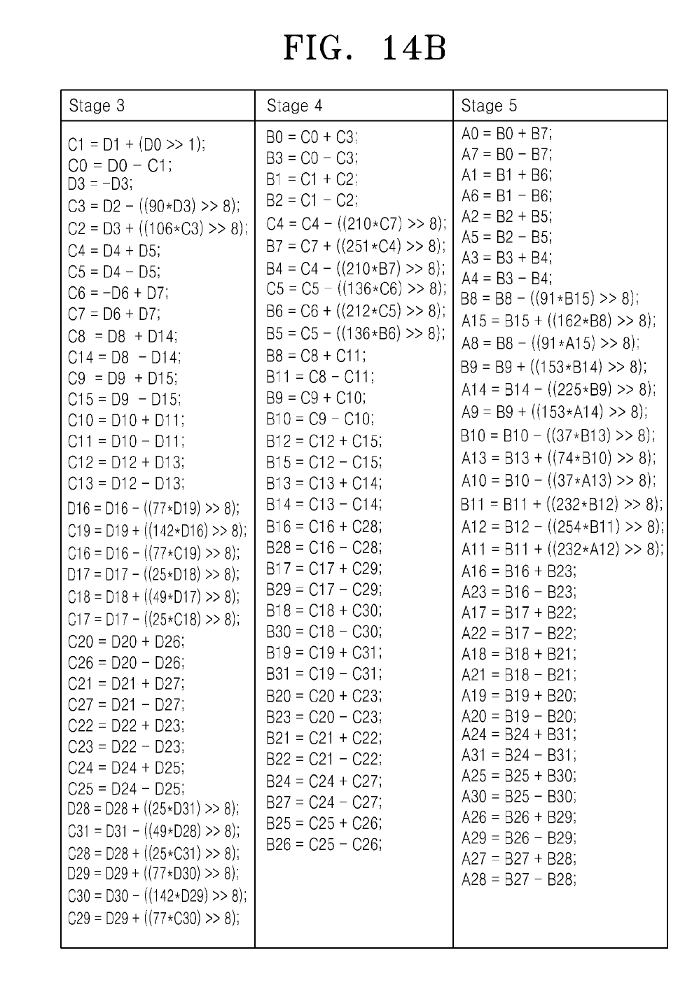

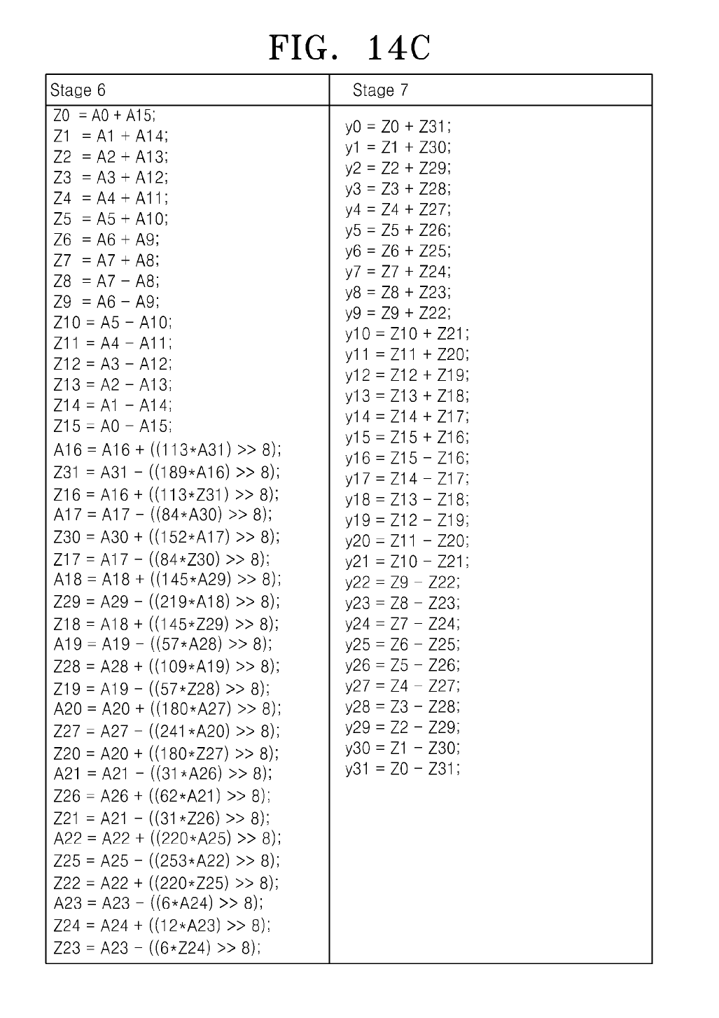

A step of performing a 32-point discrete cosine inverse transform process that is an inverse process of a 32-point DCT process that applies the operation structures 820 and 920, each of which uses the lifting scheme, to the flow graph 200 of FIG. 2 may be performed via 7-stage addition, subtraction, and shift operation processes as shown in FIGS. 14A, 14B, and 14C. In FIGS. 14A, 14B, and 14C, Y0 through Y31 are input values to be inverse transformed, X0 through X31 are inverse transformed values, and the remaining values A0 through A31, B0 through B31, C0 through C31, D0 through D31, E0 through E31, and Z0 through Z31 are intermediate values.

As described above, when the transform unit 120 substitutes a trigonometric function which is included in a DCT matrix with a rational number or with an operation structure that reduces the number of multiplications, because a DCT algorithm is changed, there may be a difference from a result value according to an original DCT algorithm. Accordingly, the quantization unit 130 minimizes a transform error by using such a substituted DCT algorithm by using a scaling matrix in a scaling process that is performed in conjunction with quantization.

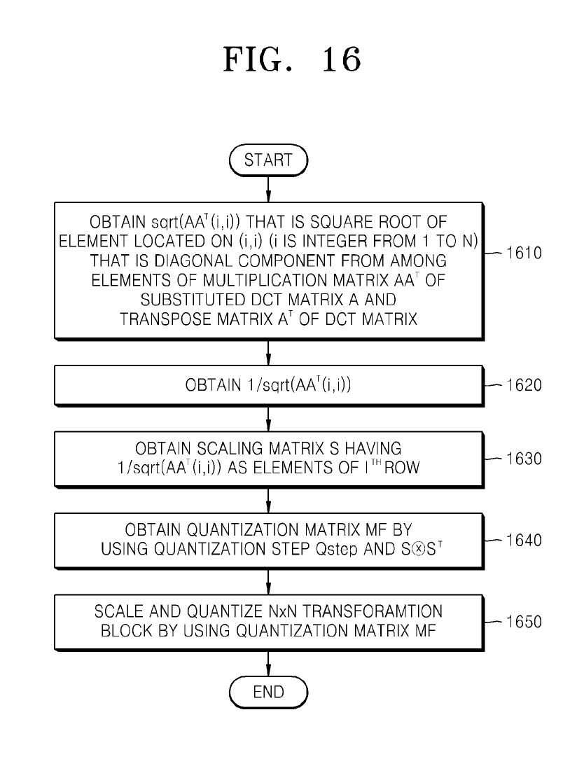

FIG. 16 is a flowchart which illustrates a quantization process, according to an exemplary embodiment.

Referring to FIGS. 1 and 16, in operation 1610, the quantization unit 130 obtains sqrt(AA^{T}(i,i)) that is a square root of an element (i,i), where i is an integer between 1 and N inclusive, which is located on a diagonal from among elements of a multiplication matrix AA^{T} of the substituted DCT matrix A and a transpose matrix A^{T} of the DCT matrix.

In operation 1620, the quantization unit 130 obtains 1/sqrt(AA^{T}(i,i)) that is a reciprocal of the square root sqrt(AA^{T}(i,i)).

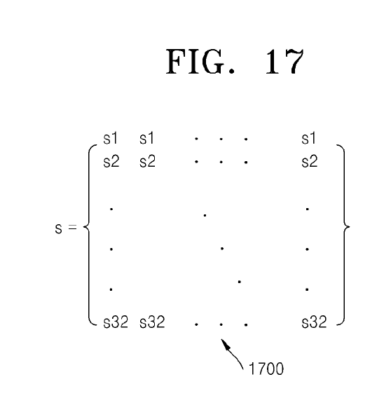

In operation 1630, the quantization unit 130 obtains a scaling matrix S that includes the reciprocal 1/sqrt(AA^{T}(i,i)) as respective elements of an i^{th} row. FIG. 17 illustrates a scaling matrix 1700 which is applicable to a transform value of a 32×32 block, according to an exemplary embodiment. Referring to FIG. 17, when the reciprocal 1/sqrt(AA^{T}(i,i)) is expressed as s(i), the quantization unit 130 generates a scaling matrix S 1700 that has all elements of the i^{th} row as s(i).

In operation 1640, the quantization unit 130 obtains a quantization matrix MF by using a quantization step Qstep and a value S\textcircled{×}S^{T} that is obtained by multiplying elements in a corresponding position of the scaling matrix S and a transpose matrix S^{T} of the scaling matrix. The symbol \textcircled{×} indicates an element-by-element multiplication, that is, an element-wise multiplication indicates an operation that multiplies respective elements in a corresponding position of a matrix.

In detail, when a matrix S\textcircled{×}S^{T} which is obtained by multiplying respective elements of the scaling matrix S by elements in a corresponding position of the transpose matrix S^{T} of the scaling matrix is PF, the quantization matrix MF may be obtained by using the following equation: MF=PF*2^{m}/Qstep. Qstep is a quantization step and m is a positive integer. For example, in an exemplary embodiment, m=10.

In operation 1650, the quantization unit 130 performs scaling and quantization on an N×N transform block by using the quantization matrix MF. In detail, the quantization unit 130 determines a size of a quantized transform coefficient by bit shift operating a first value, which is obtainable by adding a predetermined offset to a second value that is obtainable by multiplying an element in a respective position of the quantization matrix Mf by an element in the corresponding position of the N×N transform block, by q bits as determined by the following equation: q=floor(QP/6)+m, where QP is a quantization parameter. In particular, when Zij is a quantized transform coefficient value, Wij is a transform coefficient output from the transform unit 120, and f is an offset, a size of a quantization transform coefficient is determined according to the following equation: |Zij|=(|Wij|.MF+f)>>qbits. A sign of the quantized transform coefficient is determined according to the following equation: sign(|Zij|)=sign(|Wij|). ‘.MF’ denotes a vector multiplication that multiplies elements in the same position of a matrix. As described above, the vector multiplication may be expressed as \textcircled{×}. In the quantization process of operation 1650, a process for multiplying an element in a respective position of the quantization matrix MF by an element in the corresponding position of the N×N transform block corresponds to a scaling process, and a process for performing a right shift operation by q bits corresponds to a quantization process. In particular, a scaling process that compensates for a transform error due to the substituted DCT matrix A is performed in combination with a quantization process.

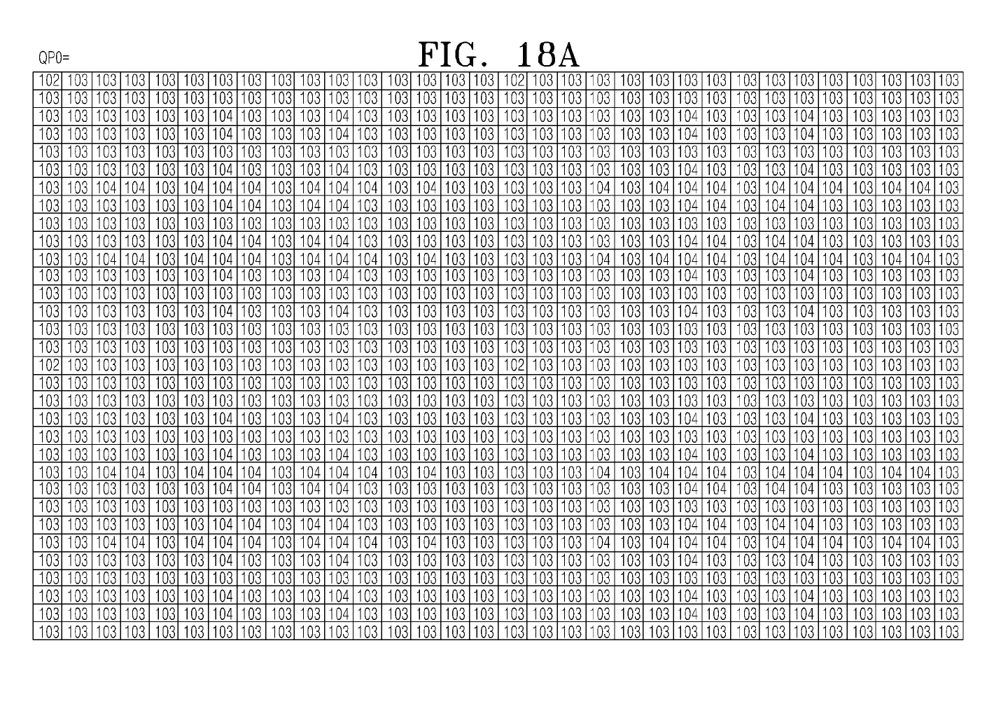

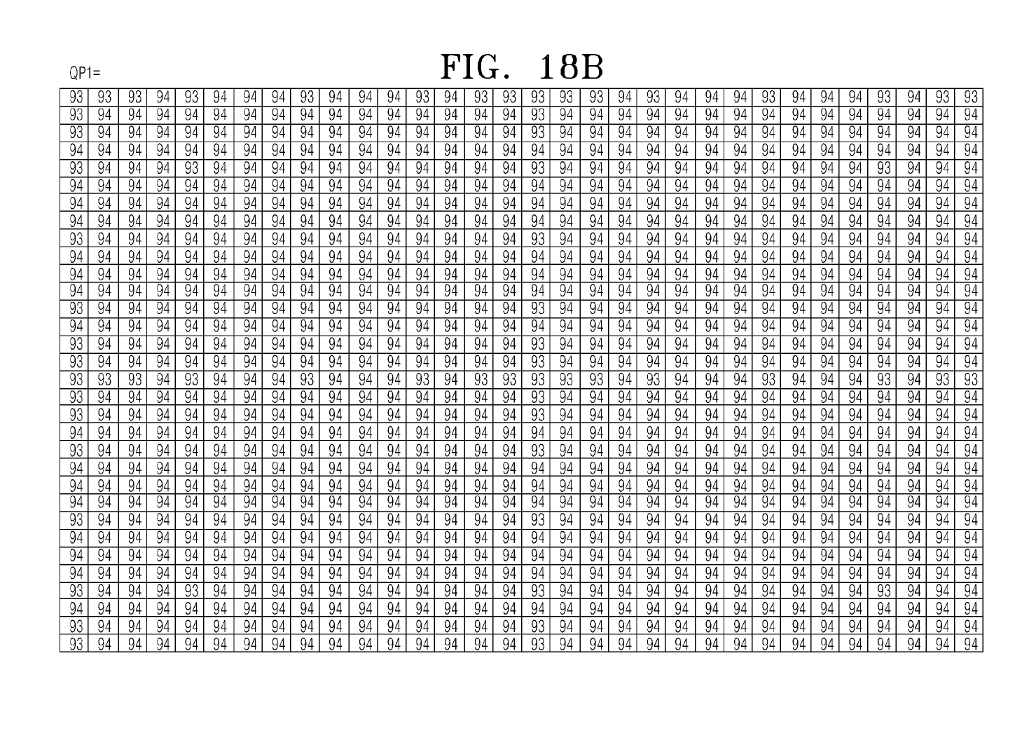

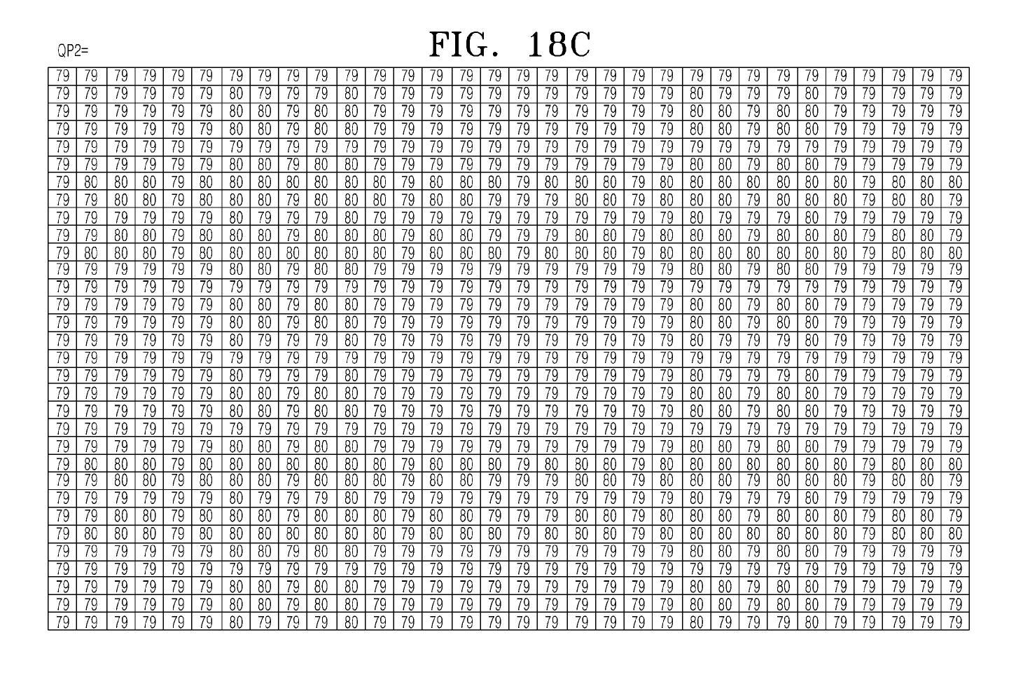

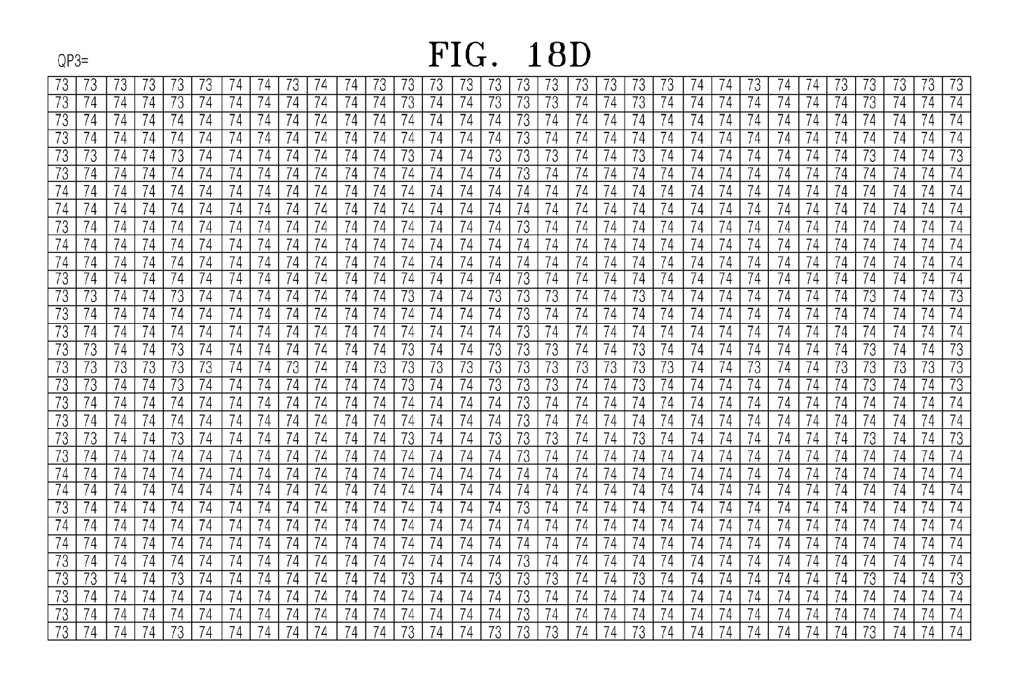

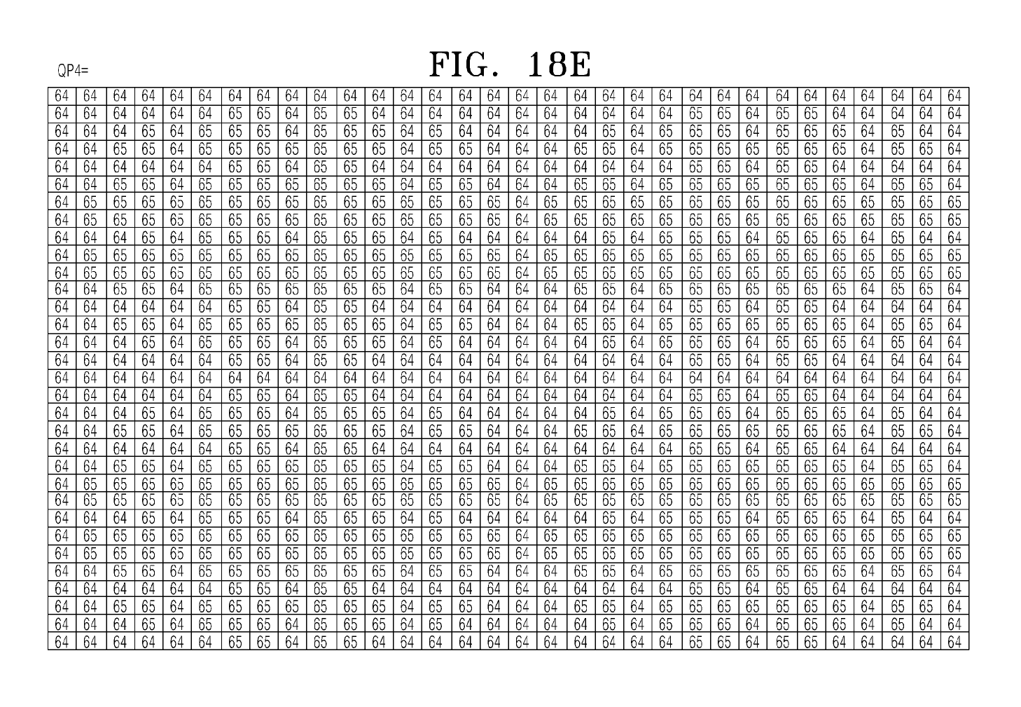

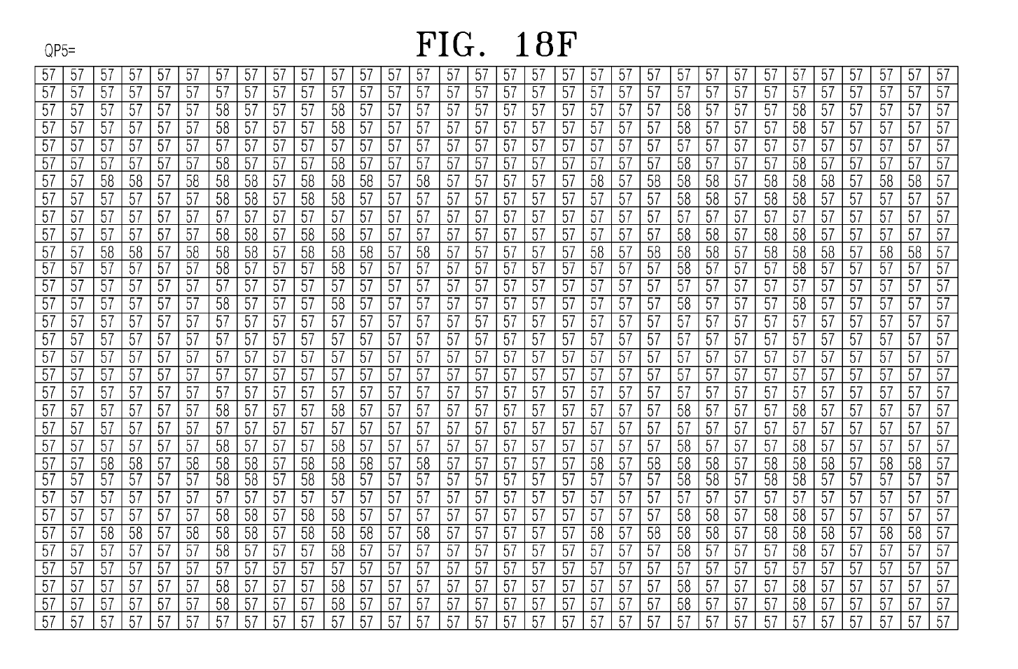

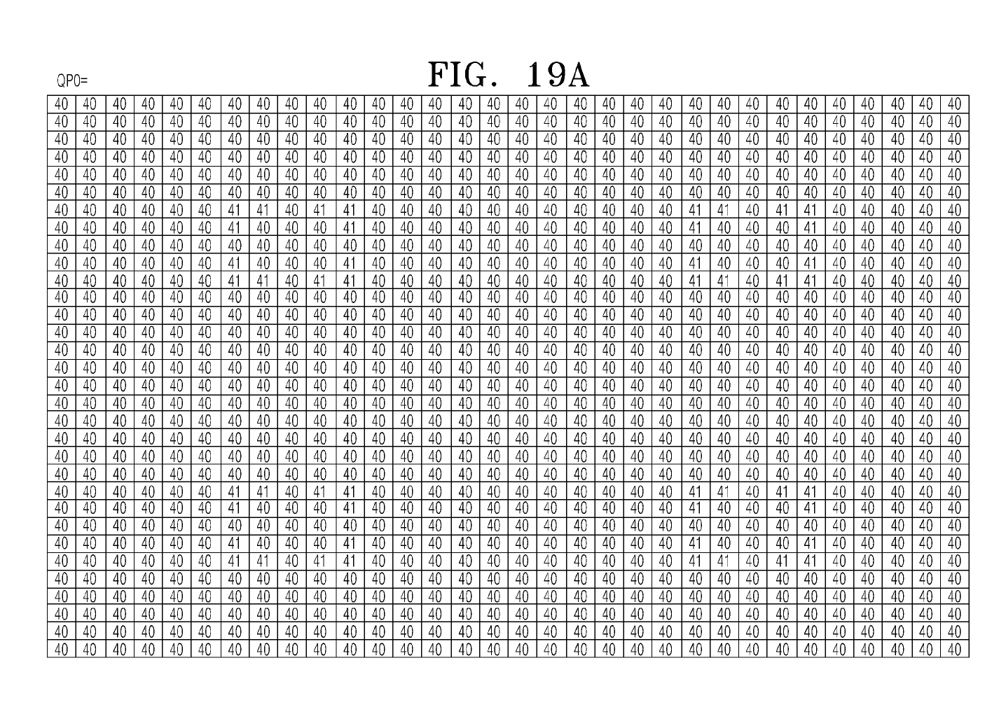

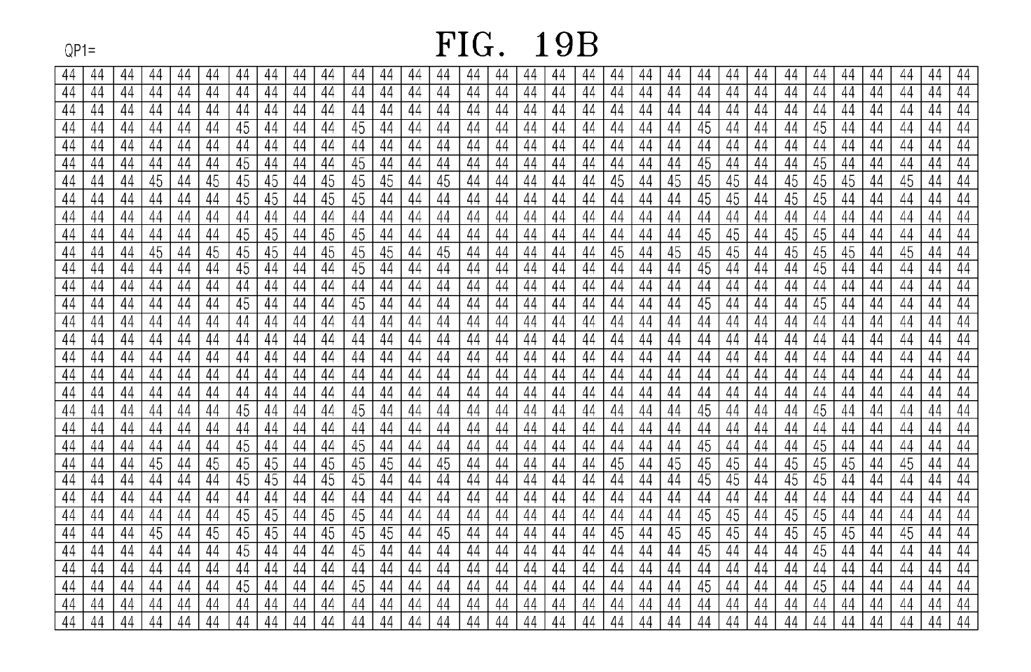

FIGS. 18A, 18B, 18C, 18D, 18E, and 18F are diagrams which illustrate the quantization matrix MF which is used to quantize a 32×32 block, according to an exemplary embodiment. In particular, FIGS. 18A, 18B, 18C, 18D, 18E, and 18F illustrate the quantization matrix MF when m=10.

The quantization matrix MF of FIGS. 18A 18B, 18C, 18D, 18E, and 18F is defined for initial 6-stage Qstep values 0.625, 0.6875, 0.8125, 0.875, 1, and 1.25 without needing to be defined in all quantization steps. This is because since the quantization step Qstep is increased 2 times as a quantization parameter QP is increased by 6, the quantization matrix MF may be defined with respect to initial 6-stage Qstep values, and the quantization matrices MF which are based on remaining quantization parameters QP may be selected by a (QP mod 6) value.

In an inverse quantization step, inverse quantization may be performed by using the inverse quantization matrix V for compensating for a difference value between the original discrete cosine inverse transform matrix Original_B and the substituted discrete cosine inverse transform matrix B.

The inverse quantization matrix V may be obtained in a similar manner to that used in the process for obtaining the quantization matrix MF. When a square root of an element (i,i), where i is an integer between 1 and N inclusive, that is a diagonal component from among elements of a multiplication matrix BB^{T} of the substituted discrete cosine inverse transform matrix B and a transpose matrix B^{T} of the substituted discrete cosine inverse transform matrix is expressed as sqrt(BB^{T}(i,i)), the scaling matrix S having 1/sqrt(BB^{T}(i,i)) as elements of an i^{th} row may be obtained, and the inverse quantization matrix V may be generated based on PF, which is the matrix S\textcircled{×}S^{T} that is obtainable by multiplying each respective element of the scaling matrix S by each element in the corresponding position of the transpose matrix S^{T} of the scaling matrix. In detail, the inverse quantization matrix V is obtainable via the following equation: V=Qstep*PF*2ⁿ, where n is an integer. For example, in an exemplary embodiment, n=10.

In detail, inverse quantization may be performed by left shifting a value that is obtainable by multiplying an element in a respective position of the inverse quantization matrix V by an element in the corresponding position of a quantized N×N transform block by floor(QP/6) bits, where floor[x] is a maximum integer less than or equal to x, and QP is a quantization parameter. In particular, when Zij is a quantized transform coefficient and Wij is an inverse quantized transform coefficient, Wij may be obtained by inverse quantizing the coefficient Zij that is quantized via the following equation: Wij=(Zij.V)<<floor(QP/6). As described above, ‘.V’ denotes a vector multiplication that multiplies elements in the same position of a matrix.

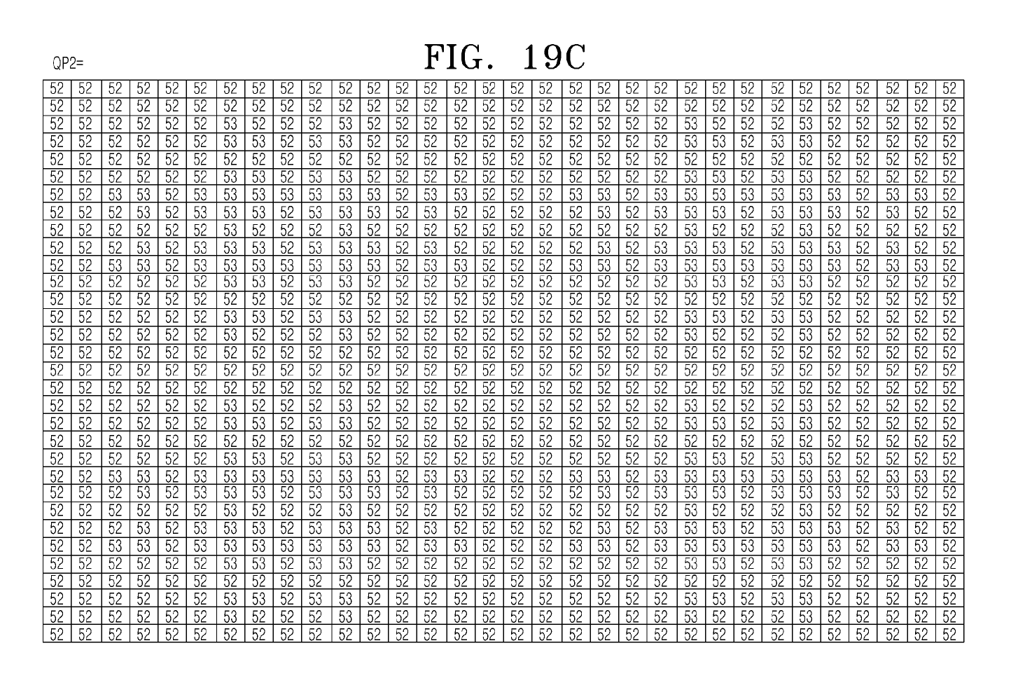

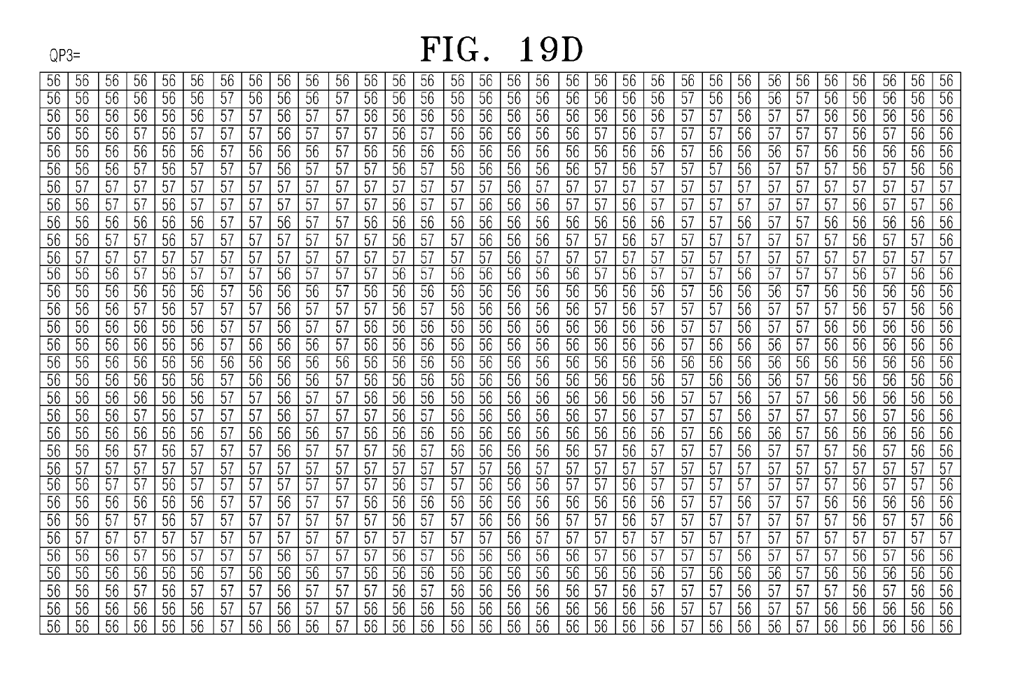

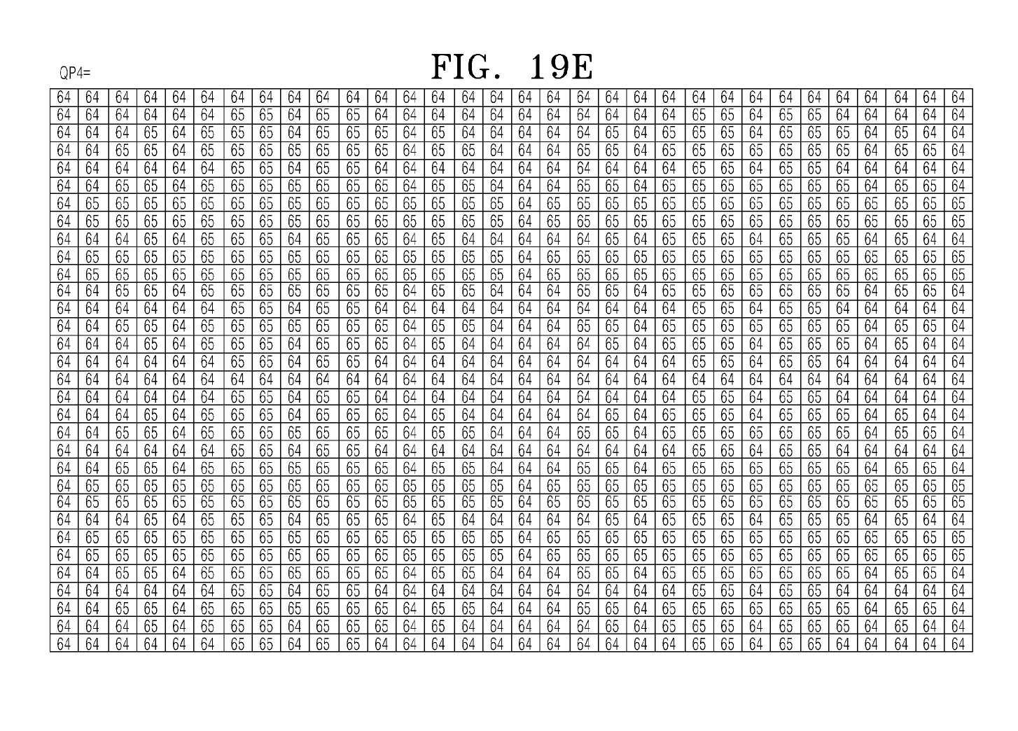

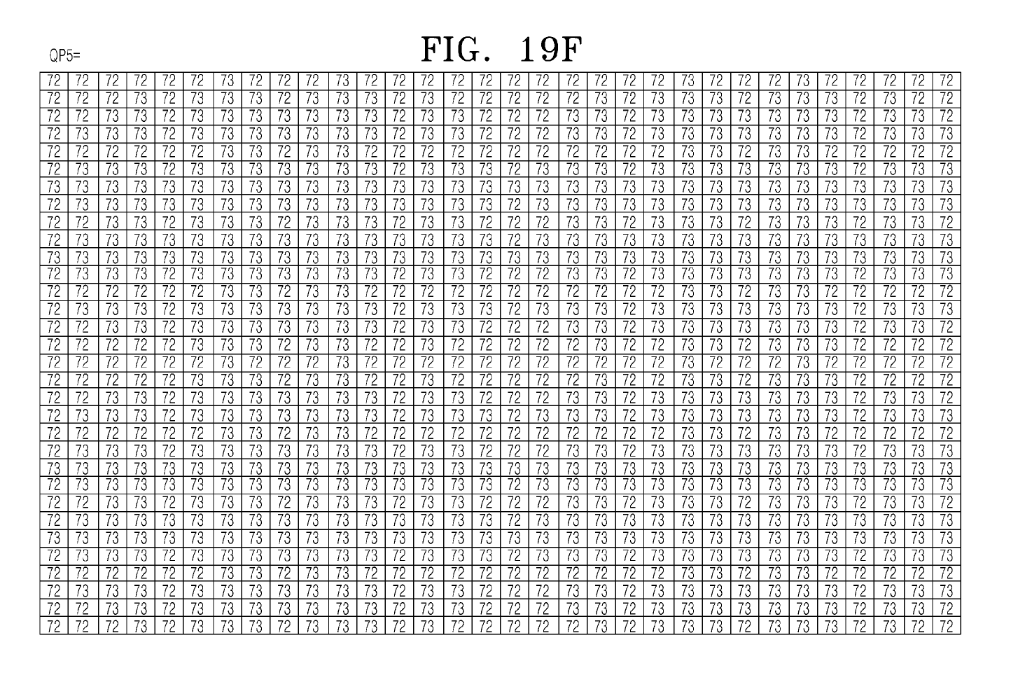

FIGS. 19A, 19B, 19C, 19D, 19E, and 19F are diagrams which illustrate the inverse quantization matrix V that is used to inverse quantize a 32×32 block, according to an exemplary embodiment. In particular, FIGS. 19A, 19B, 19C, 19D, 19E, and 19F illustrate the inverse quantization matrix V when m=10.

The inverse quantization matrix V of FIGS. 19A, 19B, 19C, 19D, 19E, and 19F is defined for initial 6-stage Qstep values 0.625, 0.6875, 0.8125, 0.875, 1, and 1.25 without needing to be defined in all quantization steps, similar as the quantization matrix MF.

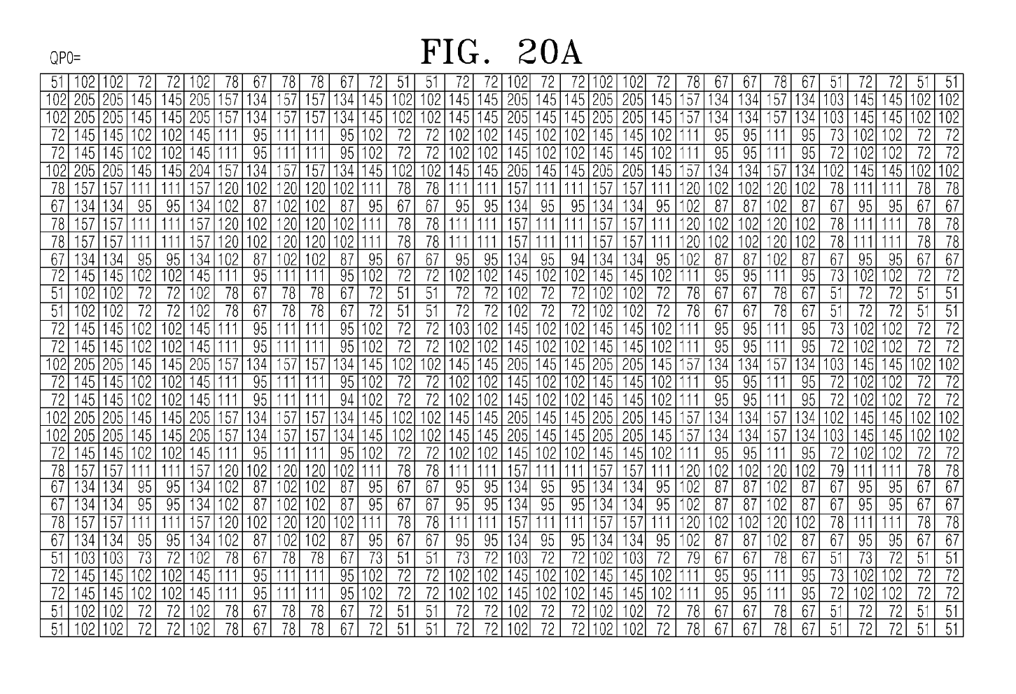

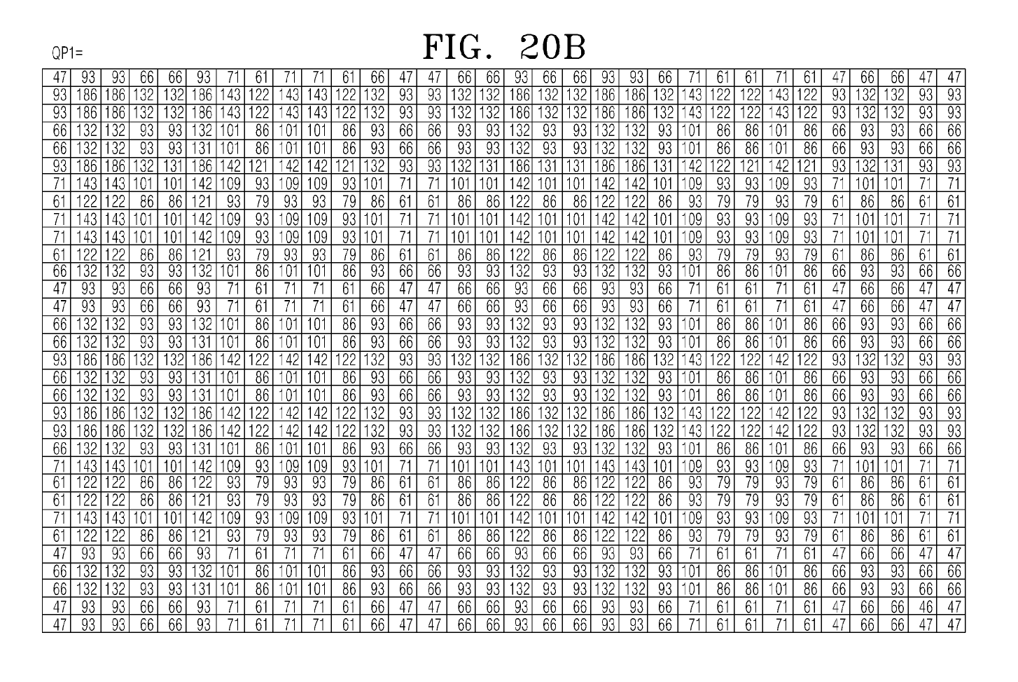

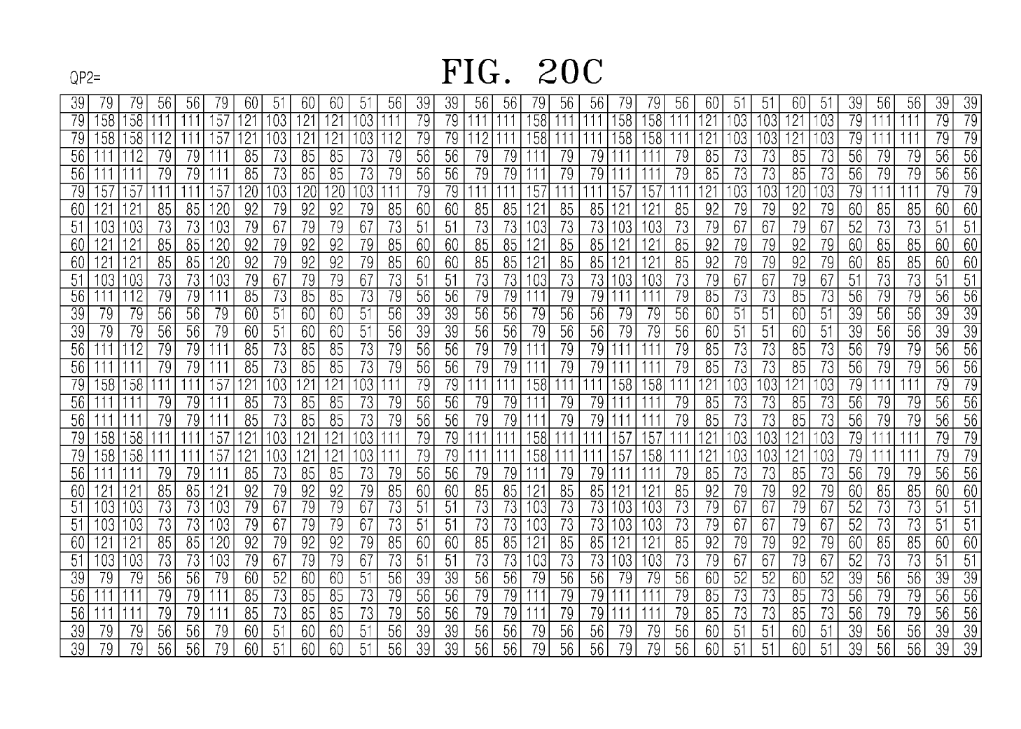

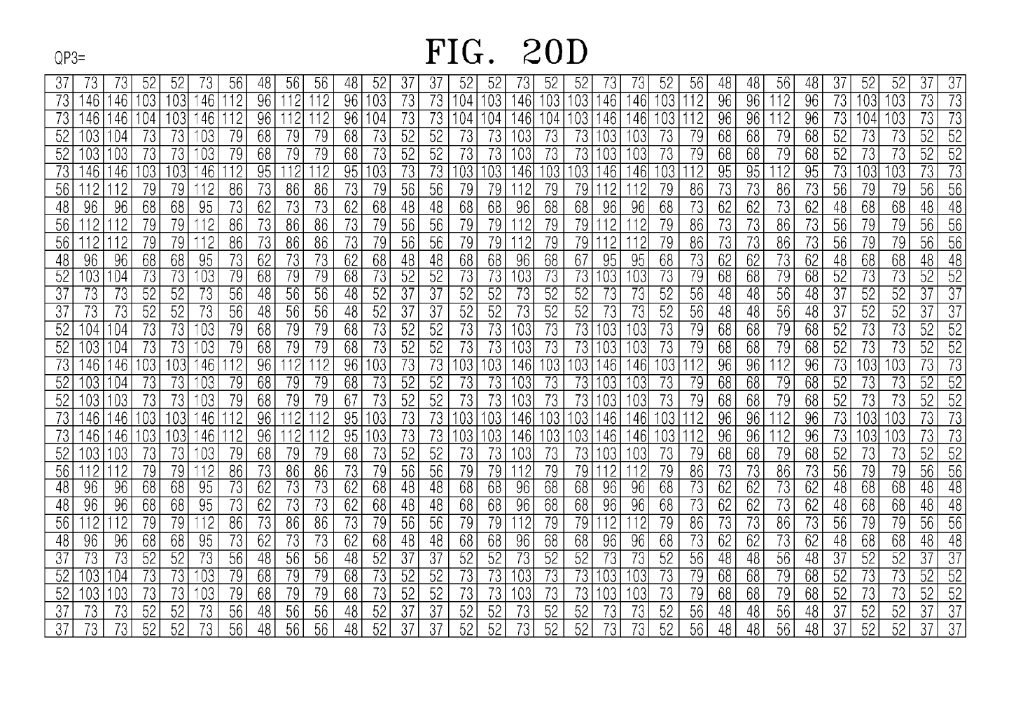

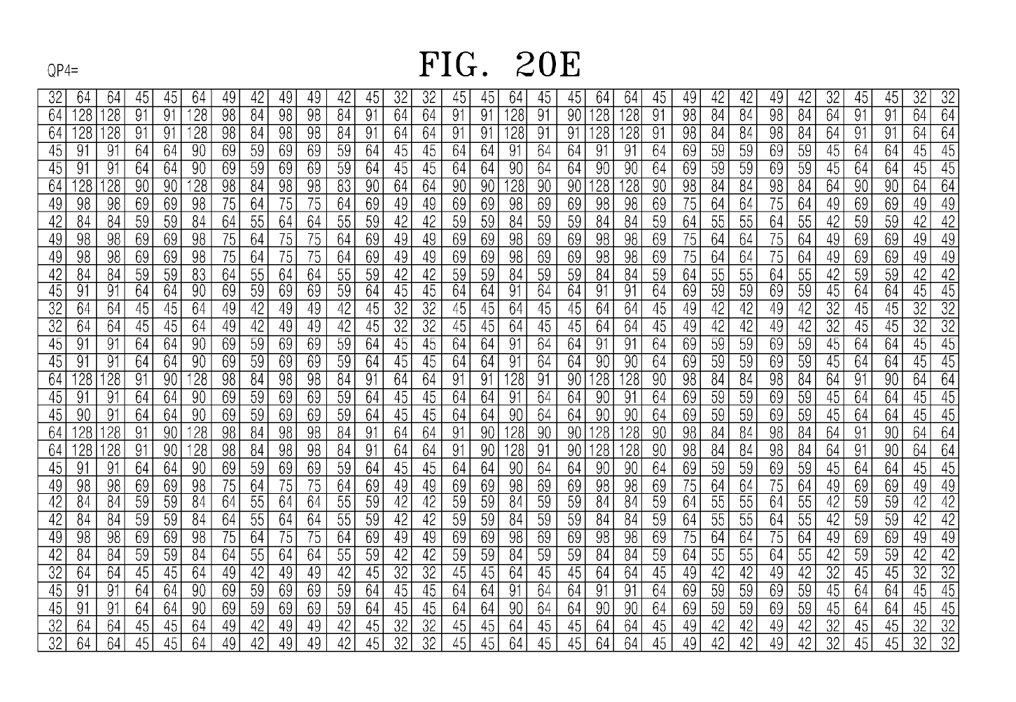

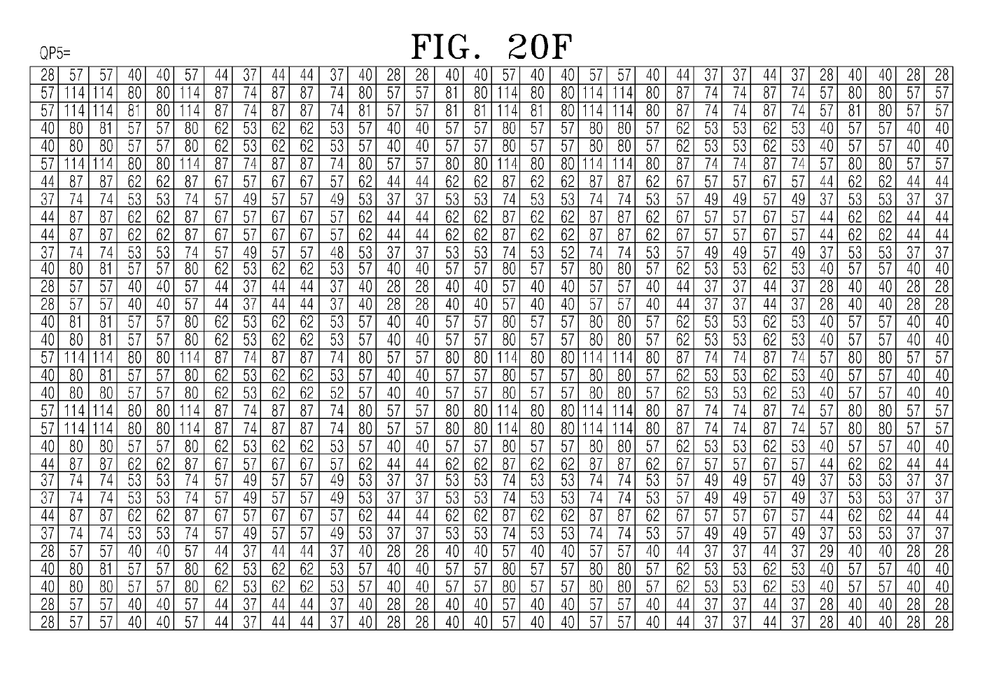

Even when the operation structures 820 and 920 which each use the lifting scheme are applied to a 32-point DCT matrix for transforming a 32×32 block, the quantization unit 130 may obtain the quantization matrix MF by using the quantization step Qstep and the value S\textcircled{×}S^{T} that is obtained by multiplying elements in the corresponding positions of the scaling matrix S and the transpose matrix S^{T} of the scaling matrix. When the matrix S\textcircled{×}S^{T} that is obtained by multiplying each respective element of the scaling matrix S by each element in the corresponding position of the transpose matrix S^{T} of the scaling matrix is PF, the quantization matrix MF may be obtained via the following equation: MF=PF*2^{m}/Qstep. FIGS. 20A, 20B, 20C, 20D, 20E, and 20F are diagrams which illustrate the quantization matrix MF which is applied to a transform block that is transformed based on a DCT matrix including an operation structure using a lifting scheme, according to another exemplary embodiment.

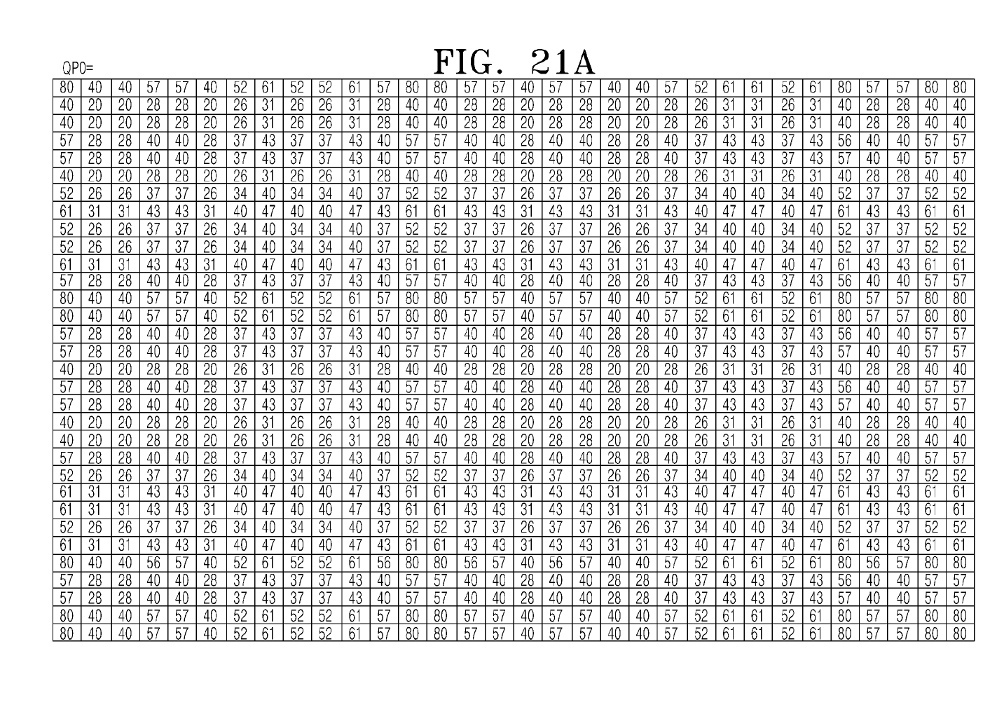

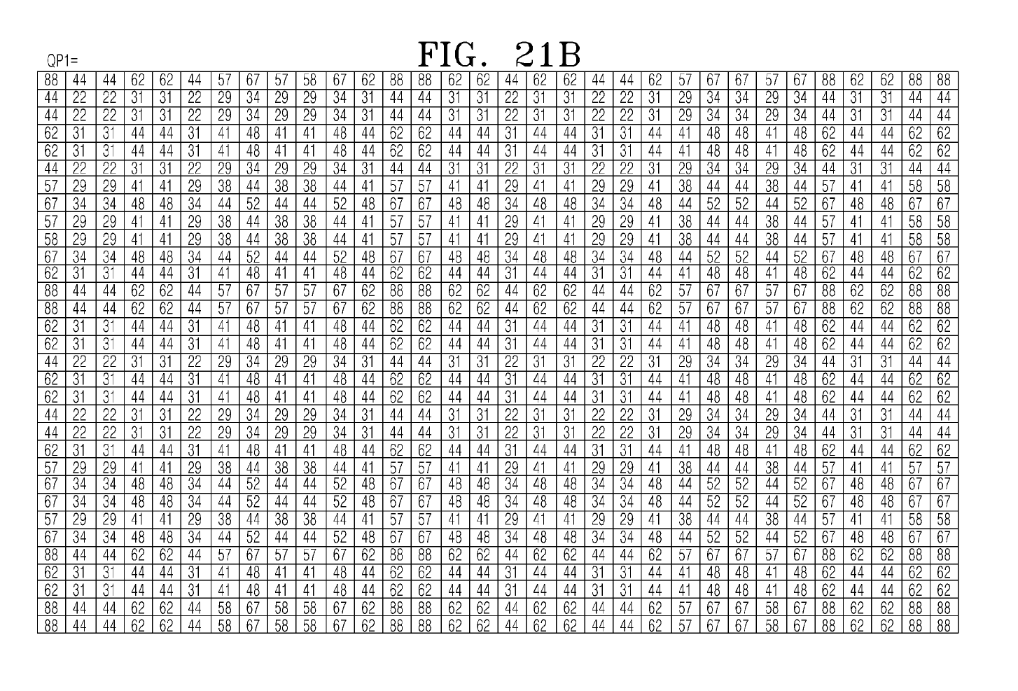

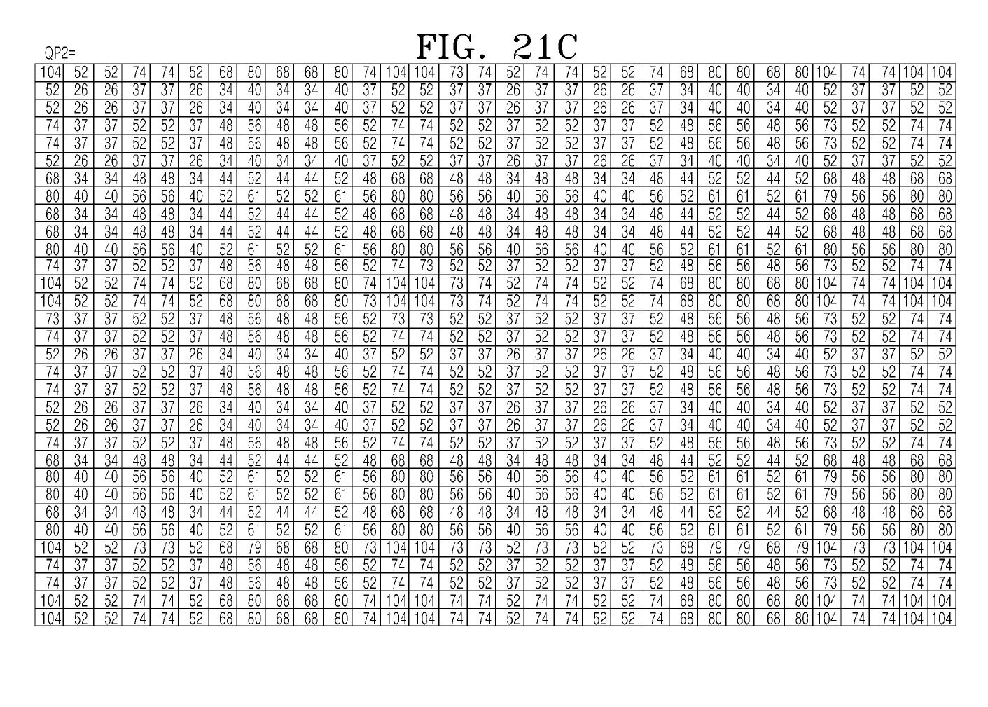

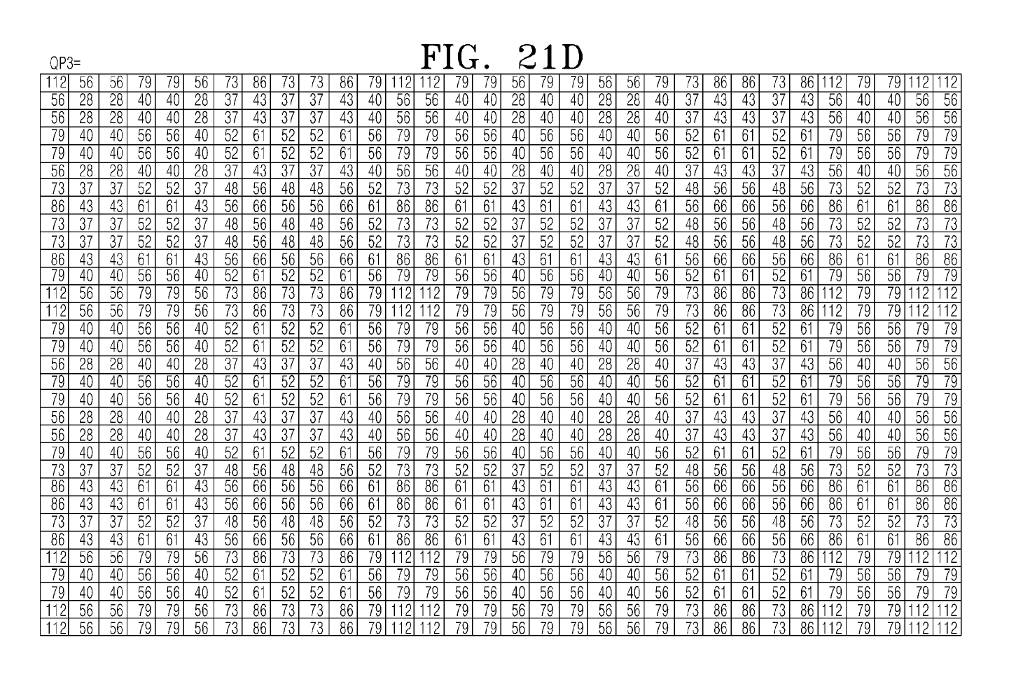

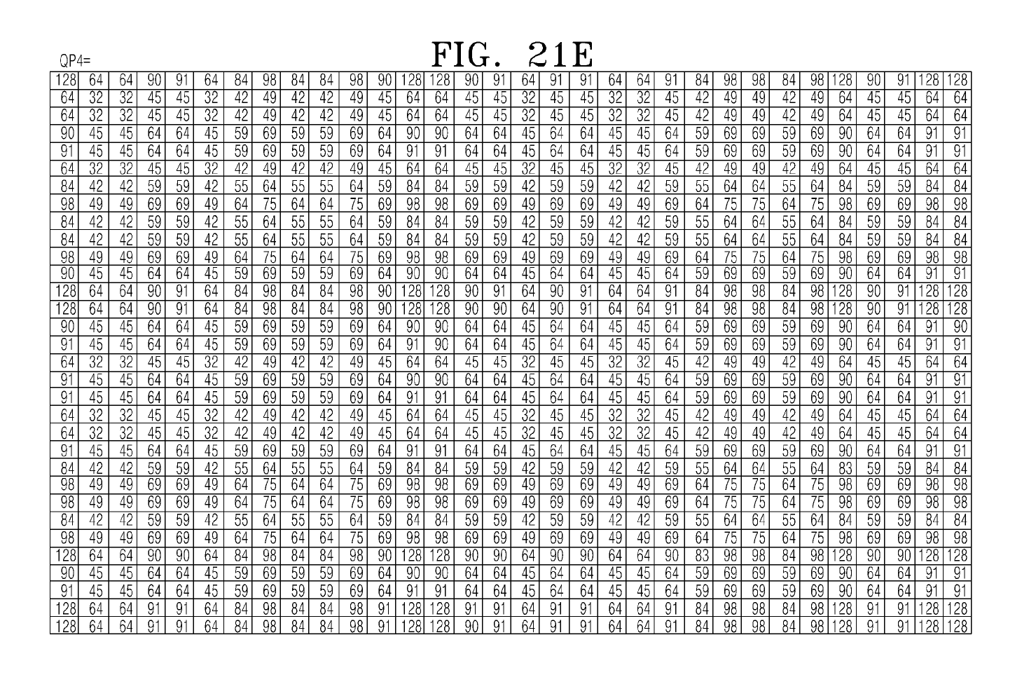

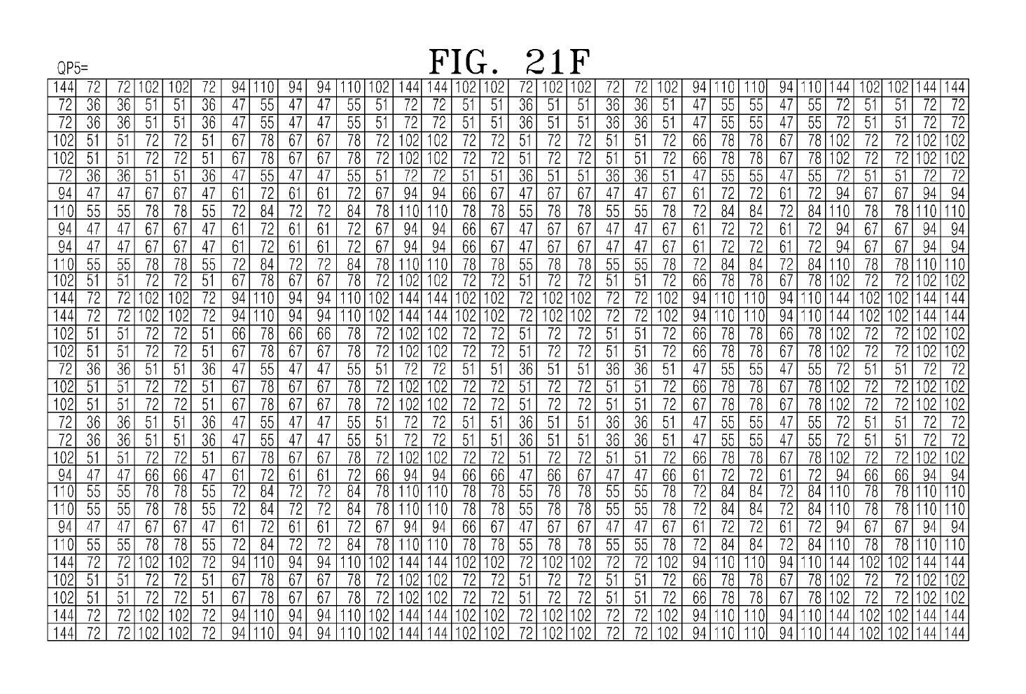

Further, when the operation structures 820 and 920 which each use the lifting scheme are applied to a 32-point discrete cosine inverse transform matrix, the inverse quantization matrix V may be generated based on PF, which is the matrix S\textcircled{×}S^{T} that is obtainable by multiplying each respective element of the scaling matrix S by each element in the corresponding position of the transpose matrix S^{T} of the scaling matrix. In detail, the inverse quantization matrix V may be obtained via the following equation: V=Qstep*PF*2ⁿ/256, where n is an integer). In the equation, ‘ 1/256’ is a value which is determined based on a size (norm) of B*(A*A^{T})*B^{T} which includes the substituted DCT matrix A and the substituted discrete cosine inverse transform matrix B. FIGS. 21A, 21B, 21C, 21D, 21E, and 21F are diagrams which illustrate the inverse quantization matrix V which is applied to a transform block that is quantized based on a discrete cosine inverse transform matrix including an operation structure using a lifting scheme, according to another exemplary embodiment.

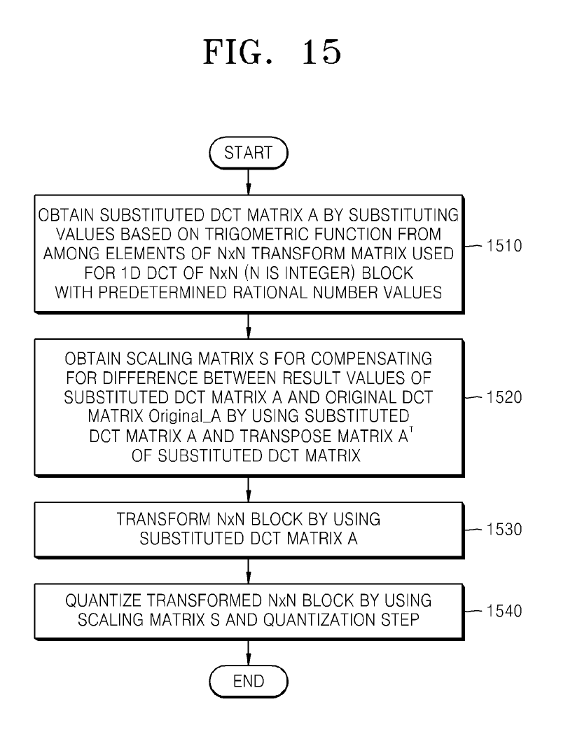

FIG. 15 is a flowchart which illustrates an image transform process, according to an exemplary embodiment.

In operation 1510, the transform unit 120 obtains the substituted DCT matrix A by substituting values which are based on a trigonometric function from among elements of an N×N transform matrix which is used for performing a 1D DCT of an N×N block, where N is an integer, with predetermined rational number values. As described above, the transform unit 120 may obtain the substituted DCT matrix A by substituting a value of a trigonometric function with a rational number and by simultaneously using the operation structures 820 and 920, each of which uses the lifting scheme, as respectively shown in FIGS. 8 and 9.

In operation 1520, the quantization unit 130 obtains the scaling matrix S which is usable for compensating for a difference between result values of the substituted DCT matrix A and the original DCT matrix Original_A by using the substituted DCT matrix A and the transpose matrix A^{T} of the substituted DCT matrix. As described above, the quantization unit 130 may obtain the scaling matrix S which includes a reciprocal of sqrt(AA^{T}(i,i)), which is a square root of an element (i,i), where i is an integer between 1 and N inclusive, which is located on a diagonal from among elements of the multiplication matrix AA^{T} of the substituted DCT matrix A and the transpose matrix A^{T} of the substituted DCT matrix, that is, 1/sqrt(AA^{T}(i,i)) as elements of an i^{th} row.

In operation 1530, the transform unit 120 transforms the N×N block by using the DCT matrix A. In operation 1540, the quantization unit 130 quantizes and scales the transformed N×N block by using the quantization matrix MF that is generated by using the quantization step and the scaling matrix S.

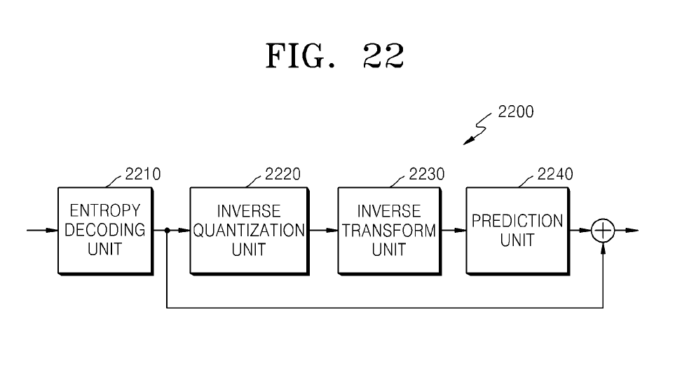

FIG. 22 is a block diagram which illustrates an image decoding apparatus 2200, according to an exemplary embodiment.

Referring to FIG. 22, the image decoding apparatus 2200 includes an entropy decoding unit 2210 (also referred to herein as an entropy decoder 2210), an inverse quantization unit 2220 (also referred to herein as an inverse quantizer 2220), an inverse transform unit 2230 (also referred to herein as an inverse transformer 2230), and a prediction unit 2240 (also referred to herein as a predictor 2240).

The entropy decoding unit 2210 extracts prediction mode information, reference picture information, and residual information which relates to a current block that is decoded from an input bitstream. The residual information corresponds to a quantized transform coefficient.

The inverse quantization unit 2220 inverse quantizes quantized transform coefficients which are extracted by the entropy decoding unit 2210. In detail, the inverse quantization unit 2220 inverse quantizes a transformed and quantized N×N block that is received by the inverse transform unit by using a quantization step and the scaling matrix S for compensating for a difference between result values of the substituted discrete cosine inverse transform matrix B and the original discrete cosine inverse transform matrix Original_B by using the substituted DCT matrix B and the transpose matrix B^{T} of the substituted discrete cosine inverse transform matrix. As described above, when a square root of an element (i,i), where i is an integer between 1 and N inclusive, that is a diagonal component from among elements of the multiplication matrix BB^{T} of the substituted discrete cosine inverse transform matrix B and the transpose matrix B^{T} of the substituted discrete cosine inverse transform matrix is expressed as sqrt(BB^{T}(i,i)), the scaling matrix S may be a matrix which includes 1/sqrt(BB^{T}(i,i)) as elements of an i^{th} row. The inverse quantization unit 2220 may obtain the inverse quantization matrix V based on PF, which is the matrix S\textcircled{×}S^{T} that is obtainable by multiplying each respective element of the scaling matrix S by each element in the corresponding position of a transpose matrix S^{T} of the scaling matrix. In detail, the inverse quantization matrix V is obtainable via the following equation: V=Qstep*PF*2ⁿ, where n is an integer.

When the inverse quantization matrix V is determined, the inverse quantization unit 2220 performs inverse quantization by left shifting a value that is obtainable by multiplying a respective element of the inverse quantization matrix V by an element in the corresponding position of an N×N transform block by floor(QP/6) bits, where floor[x] is a maximum integer less than or equal to x, and QP is a quantization parameter. In particular, when Zij is a quantized transform coefficient and Wij is an inverse quantized transform coefficient, the quantization unit 2220 may obtain Wji by inverse quantizing the coefficient Zij that is quantized via the following equation: Wij=(Zij.V)<<floor(QP/6).

The inverse transform unit 2230 inverse transforms transform coefficients that are inverse quantized by using the substituted discrete cosine inverse transform matrix B that is obtainable by substituting values which are based on a trigonometric function from among elements of the N×N discrete cosine inverse transform matrix Original_B with predetermined rational number values. As a result of the inverse transform, residual values of a block unit are restored. An inverse transform process may be performed by using the substituted discrete cosine inverse transform matrix B that is obtainable via various exemplary embodiments. For example, the substituted discrete cosine inverse transform matrix B that is substituted by applying a lifting scheme to an operation structure of the N×N discrete cosine inverse transform matrix Original_B may be used in an inverse transform process.

The prediction unit 2240 generates a prediction value based on the prediction mode information, and the prediction value and a residual signal restored by the inverse transform unit 2230 are added to restore an image.

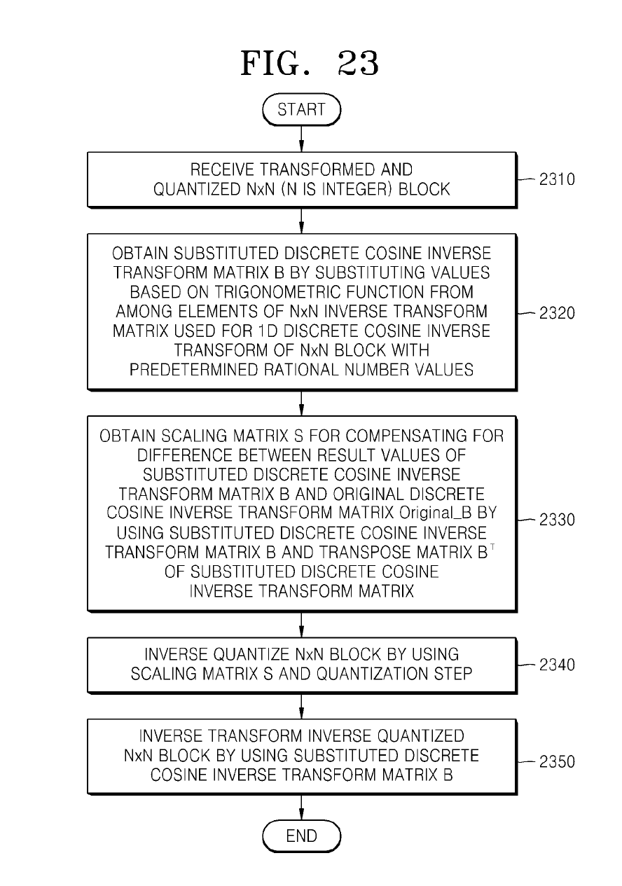

FIG. 23 is a flowchart which illustrates an image inverse transform method, according to an exemplary embodiment.

Referring to FIG. 23, in operation 2310, the entropy decoding unit 2210 parses and outputs a transformed and quantized N×N block from a bitstream, wherein N is an integer.

In operation 2320, the inverse transform unit 2230 obtains the substituted discrete cosine inverse transform matrix B by substituting values which are based on a trigonometric function from among elements of an N×N inverse transform matrix which is used for performing a 1D discrete cosine inverse transform of an N×N block with predetermined rational number values.

In operation 2330, the inverse quantization unit 2220 obtains the scaling matrix S which is usable for compensating for a difference between result values of the substituted discrete cosine inverse transform matrix B and the original discrete cosine inverse transform matrix Original_B by using the substituted discrete cosine inverse transform matrix B and the transpose matrix B^{T} of the substituted discrete cosine inverse transform matrix. As described above, when a square root of an element (i,i), where i is an integer between 1 and N inclusive, that is a diagonal component from among elements of the multiplication matrix BB^{T} of the substituted discrete cosine inverse transform matrix B and the transpose matrix B^{T} of the substituted discrete cosine inverse transform matrix is expressed as sqrt(BB^{T}(i,i)), the scaling matrix S may be a matrix which includes 1/sqrt(BB^{T}(i,i)) as elements of an i^{th} row.

In operation 2340, the inverse quantization unit 2220 inverse quantizes the N×N block by using a quantization step and the scaling matrix S. As described above, the inverse quantization unit 2220 obtains the inverse quantization matrix V based on PF, which is the matrix S\textcircled{×}S^{T} that is obtainable by multiplying each respective element of the scaling matrix S by each element in the corresponding position of the transpose matrix S^{T} of the scaling matrix, and performs inverse quantization by left shifting a value that is obtainable by multiplying a respective element of the inverse quantization matrix V by an element in the corresponding position of a quantized N×N transform block by floor(QP/6) bits, where floor[x] is a maximum integer less than or equal to x, and QP is a quantization parameter. In particular, when Zij is a quantized transform coefficient and Wij is an inverse quantized transform coefficient, the quantization unit 2220 may obtain Wij by inverse quantizing the coefficient Zij that is quantized via the following equation: Wij=(Zij.V)<<floor(QP/6).

In operation 2350, the inverse transform unit 2230 inverse transforms the inverse quantized N×N block by using the substituted discrete cosine inverse transform matrix B.

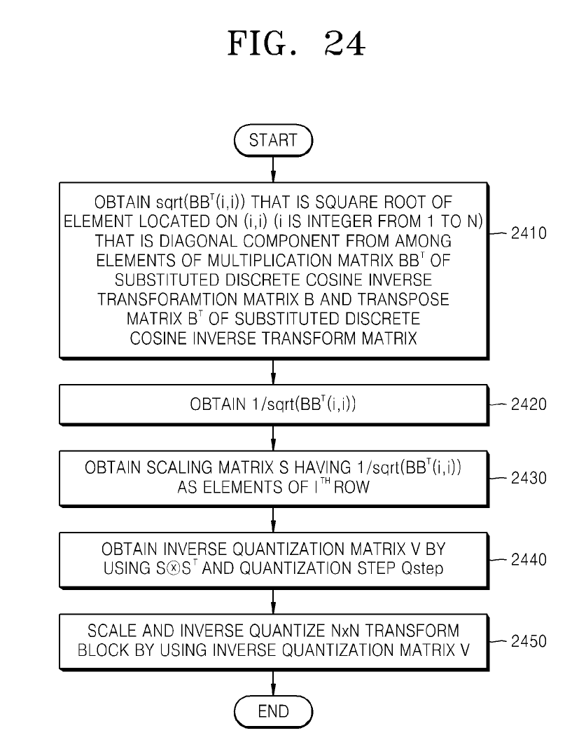

FIG. 24 is a flowchart which illustrates a process for obtaining the inverse quantization matrix V, according to an exemplary embodiment.

Referring to FIG. 24, in operation 2410, the inverse quantization unit 2230 obtains sqrt(BB^{T}(i,i)) that is a square root of an element (i,i), where i is an integer between 1 and N inclusive, that is a diagonal component from among elements of the multiplication matrix BB^{T} of the substituted discrete cosine inverse transform matrix B and the transpose matrix B^{T} of the substituted discrete cosine inverse transform matrix.

In operation 2420, the inverse quantization unit 2230 obtains 1/sqrt(BB^{T}(i,i)) that is a reciprocal of the square root sqrt(BB^{T}(i,i)). In operation 2430, the inverse quantization unit 2230 obtains the scaling matrix S which includes the reciprocal 1/sqrt(BB^{T}(i,i)) as an element of an i^{th} row.

In operation 2440, the inverse quantization unit 2230 generates the inverse quantization matrix V based on PF, which is the matrix S\textcircled{×}S^{T} that is obtainable by multiplying each respective element of the scaling matrix S by each element in the corresponding position of the transpose matrix S^{T} of the scaling matrix. In detail, the inverse quantization matrix V may be obtained via the following equation: V=Qstep*PF*2ⁿ, where n is an integer.

In operation 2450, the inverse quantization unit 2230 performs scaling and inverse quantization by left shifting a value that is obtainable by multiplying a respective element of the inverse quantization matrix V by an element in the corresponding position of a quantized N×N transform block by floor(QP/6) bits, where floor[x] is a maximum integer less than or equal to x, and QP is a quantization parameter. In particular, when Zij is a quantized transform coefficient and Wij is an inverse quantized transform coefficient, Wij may be obtained by inverse quantizing the coefficient Zij that is quantized via the following equation: Wij=(Zij.V)<<floor(QP/6).

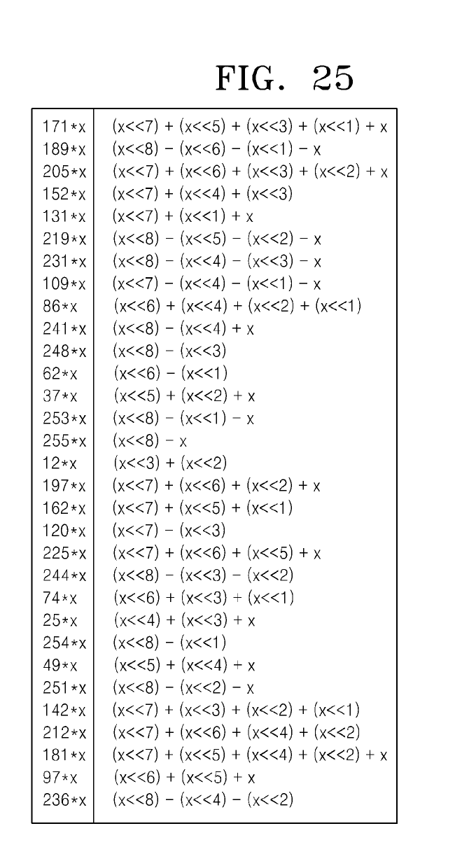

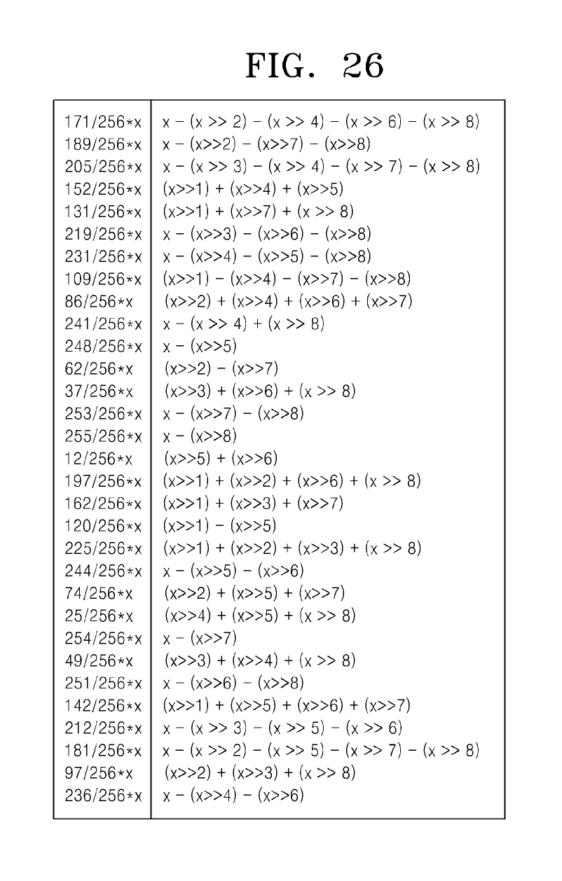

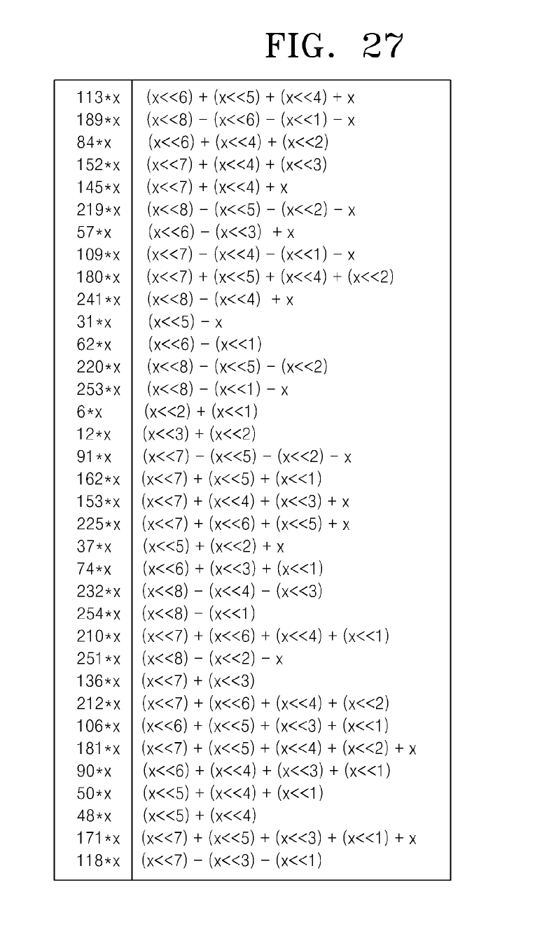

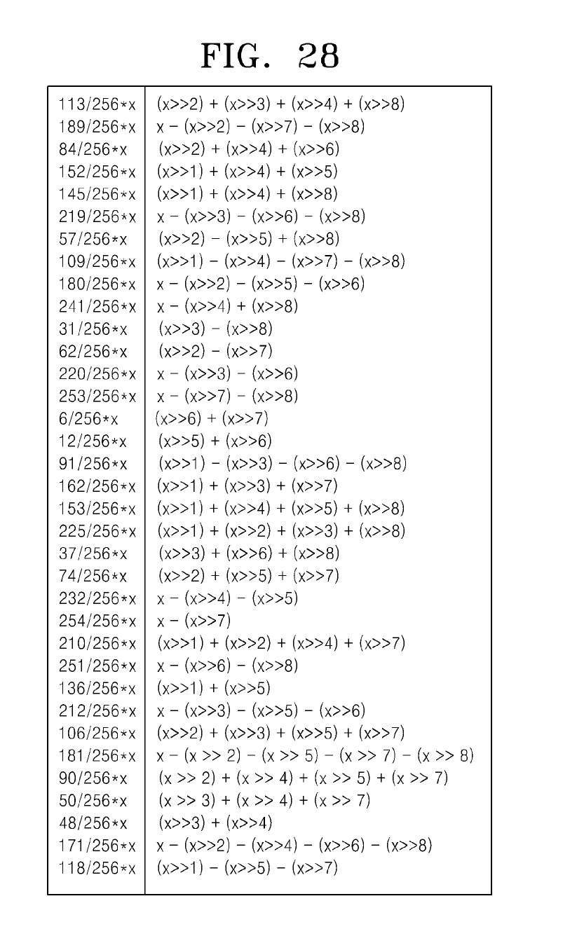

A specific multiplication that is performed in transform and inverse transform processes which use the substituted DCT matrix A and the substituted discrete cosine inverse transform matrix B may be reconstructed to include only several shift operations and additions and subtractions, instead of a multiplication process, based on mapping tables shown in FIGS. 25, 26, 27, and 28. In FIGS. 25 and 27, a multiplication and a right reconstructed operation have the same result value. In FIGS. 26 and 28, a multiplication and a right reconstructed operation have a rounding error therebetween with a relatively small performance drop.

While the present inventive concept has been particularly shown and described with reference to exemplary embodiments thereof, they are provided for the purposes of illustration and it will be understood by those of ordinary skill in the art that various modifications and equivalent other embodiments can be made from the present inventive concept. Accordingly, the true technical scope of the present inventive concept is defined by the technical spirit of the appended claims, and various modifications and equivalent other embodiments may be made from the present inventive concept. The present inventive concept may be embodied as computer-readable codes on a transitory or non-transitory computer-readable recording medium. The computer-readable recording medium may include any data storage device that can store data which can be thereafter read by a computer system. Examples of the computer-readable recording medium include read-only memories (ROMs), random-access memories (RAMs), CD-ROMs, magnetic tapes, floppy disks, optical data storage devices, etc. The computer-readable recording medium can also be distributed over network coupled computer systems so that the compute readable code is stored and executed in a distributed fashion.

1. An image transform method comprising:
obtaining a substituted discrete cosine transform (DCT) matrix A by substituting values which are based on a trigonometric function from among elements of an N×N transform matrix, where N is an integer, that is used for performing a one-dimensional (1D) DCT of an N×N block with rational number values;
obtaining a scaling matrix S which is used for compensating for a difference between result values of the substituted DCT matrix A and an original DCT matrix Original_A by using the substituted DCT matrix A and a transpose matrix A^{T} of the substituted DCT matrix A;
transforming the N×N block by using the substituted DCT matrix A; and
quantizing the transformed N×N block by using the scaling matrix S and a quantization step.

2. The image transform method of claim 1, wherein the obtaining of the substituted DCT matrix A comprises substituting each of the values which is based on the trigonometric function with a respective rational number whose denominator is equal to a power of 2.

3. The image transform method of claim 1, wherein when a square root of an element (i,i), where i is an integer between 1 and N inclusive, that is a diagonal component from among elements of a multiplication matrix AA^{T} of the substituted DCT matrix A and the transpose matrix A^{T} of the substituted DCT matrix A is expressed as sqrt(AA^{T}(i,i)), the scaling matrix S is a matrix which includes 1/sqrt(AA^{T}(i,i)) as elements of an i^{th} row.

4. The image transform method of claim 1, wherein the transforming is performed by using, in place of a multiplication which is included in a transform process using the substituted DCT matrix A, a sequence of operations which includes a shift operation, an addition, and a subtraction.

5. The image transform method of claim 1, wherein the quantizing comprises:
when the quantization step is expressed as Qstep, a matrix which is obtained by multiplying elements of the scaling matrix S by elements in a corresponding position of a transpose matrix S^{T} of the scaling matrix S is expressed as PF, and m is a positive integer, obtaining a quantization matrix MF with which scaling which is obtained via an equation MF=PF*2^{m}/Qstep is combined; and
performing quantization on the transformed N×N block by using the obtained quantization matrix MF.

6. The image transform method of claim 5, wherein the performing the quantization comprises performing the quantization by bit shift operating a first value, which is obtained by adding a predetermined offset to a second value that is obtained by multiplying elements in a corresponding position of the quantization matrix MF and the transformed N×N block, by q bits according to an equation q=floor(QP/6)+m, where m is an integer, floor[x] is a maximum integer which is less than or equal to x, and QP is a quantization parameter.

7. An image inverse transform method comprising:
receiving a transformed and quantized N×N block, where N is an integer;
obtaining a substituted discrete cosine inverse transform matrix B by substituting values which are based on a trigonometric function from among elements of an N×N inverse transform matrix that is used for performing a one-dimensional (1D) discrete cosine inverse transform of the N×N block with predetermined rational number values;
obtaining a scaling matrix S which is used for compensating for a difference between result values of the substituted discrete cosine inverse transform matrix B and an original discrete cosine inverse transform matrix Original_B by using the substituted discrete cosine inverse transform matrix B and a transpose matrix B^{T} of the substituted discrete cosine inverse transform matrix B;
inverse quantizing the N×N block by using the scaling matrix S and a quantization step; and
inverse transforming the inverse quantized N×N block by using the substituted discrete cosine inverse transform matrix B.

8. The image inverse transform method of claim 7, wherein the obtaining of the substituted discrete cosine inverse transform matrix B comprises substituting each of the values based on the trigonometric function with a respective rational number whose denominator is equal to a power of 2.

9. The image inverse transform method of claim 7, wherein when a square root of an element (i,i), where i is an integer between 1 and N inclusive, that is a diagonal component from among elements of a multiplication matrix BB^{T} of the substituted discrete cosine inverse transform matrix B and the transpose matrix B^{T} of the substituted discrete cosine inverse transform matrix B is expressed as sqrt(BB^{T}(i,i)), the scaling matrix S is a matrix which includes 1/sqrt(BB^{T}(i,i)) as elements of an i^{th} row.

10. The image inverse transform method of claim 7, wherein the inverse transforming is performed by using, in place of a multiplication which is included in a transform process using the substituted discrete cosine inverse transform matrix B, a sequence of operations which includes a shift operation, an addition, and a subtraction.

11. The image inverse transform method of claim 7, wherein the inverse quantizing comprises:
when the quantization step is expressed as Qstep, a matrix which is obtained by multiplying elements of the scaling matrix S by elements in a corresponding position of a transpose matrix S^{T} of the scaling matrix S is expressed as PF, and n is a positive integer, obtaining an inverse quantization matrix V with which scaling which is obtained via an equation V=Qstep*PF*2ⁿ is combined; and
performing inverse quantization on the N×N block by using the obtained inverse quantization matrix V.

12. The image inverse transform method of claim 11, wherein the performing the inverse quantization comprises performing the inverse quantization by bit shift operating a value, which is obtained by multiplying elements in a corresponding position of the inverse quantization matrix V and the N×N block, by floor(QP/6) bits, where floor[x] is a maximum integer which is less than or equal to x and QP is a quantization parameter.

13. An image encoding apparatus comprising:
a transformer which is configured to transform an N×N block, where N is an integer, by using a substituted discrete cosine transform (DCT) matrix A that is obtained by substituting values which are based on a trigonometric function from among elements of an N×N transform matrix that is used for performing a one-dimensional (1D) DCT of the N×N block with predetermined rational number values; and
quantizer which is configured to quantize the transformed N×N block by using a quantization step and a scaling matrix S for compensating for a difference between result values of the substituted DCT matrix A and an original DCT matrix Original_A by using the substituted DCT matrix A and a transpose matrix A^{T} of the substituted DCT matrix A.

14. An image decoding apparatus comprising:
an inverse transformer which is configured to inverse transform a transformed and quantized N×N block, where N is an integer, by using a substituted discrete cosine inverse transform matrix B that is obtained by substituting values which are based on a trigonometric function from among elements of an N×N inverse transform matrix which is used for performing a one-dimensional (1D) discrete cosine inverse transform of the N×N block with predetermined rational number values; and
an inverse quantizer which is configured to inverse quantize the transformed and quantized N×N block that is received by the inverse transformer by using a quantization step and a scaling matrix S for compensating for result values of the substituted discrete cosine inverse transform matrix B and an original discrete cosine inverse transform matrix Original_B by using the substituted discrete cosine inverse transform matrix B and a transpose matrix B^{T} of the substituted discrete cosine inverse transform matrix B.

15. A non-transitory computer-readable recording medium having embodied thereon a program code for executing the image transform method of claim 1.
